(19) United States
(12) Patent Application Publication
(10) Pub. No.: US 2017/0203503 A1
(43) Pub. Date: Jul. 20, 2017

(54) Wind-by-Wind Printer and Printing Method

(71) Applicant: Mordechai Teicher, Hod-Hasharon (IL)

(72) Inventor: Mordechai Teicher, Hod-Hasharon (IL)

(21) Appl. No.: 15/001,270

(22) Filed: Jan. 20, 2016

(51) Int. Cl. B29C 67/00; B29C 53/56

(52) U.S. Cl. CPC B29C 67/0055; B29C 53/56; B29C 67/0088; B33Y 10/00

(57) ABSTRACT

A wind-by-wind printer of three-dimensional envelopes is disclosed. A partial envelope is rotated by a turntable, a printhead is positioned proximate to a pervious fiber wind according to a three-dimensional model of the complete envelope, and unmelted fiber is dispensed and joined to the pervious wind. Several source fibers may be merged into a single build fiber toward printing. The source fiber may be modified toward printing, for example by shaping, painting or heating without melting. Several printing units may concurrently operate for adding several fiber winds to the envelope during a single revolution of the turntable.

### CROSS REFERENCE TO RELATED APPLICATIONS

This application claims the benefits of U.S. provisional patent application No. 62/119,201 filed on Feb. 22, 2015, and U.S. provisional patent application No. 62/146,265 filed on Apr. 11, 2015, the contents of both applications incorporated by reference in their entirety as if set forth herein.

### BACKGROUND

Field

The present disclosure relates to printing of three-dimensional objects, and specifically to computer-controlled printing of three-dimensional envelopes.

Description of Related Art

Computer-controlled printing of three-dimensional objects is available using a variety of printing technologies and materials. Generally speaking, for printing larger objects, existing three-dimensional printing methods and systems suffer from one or more of the following drawbacks: long printing time; expensive printing materials; limited choice of materials and material properties; large amount of waste; environmentally-unfriendly materials; and heavy builds that are difficult to handle and transport.

Thus, there is a need for better methods and systems for printing larger objects. This need is addressed by the present disclosure.

### BRIEF SUMMARY

The present disclosure teaches methods and systems for building envelopes by computer-controlled dispensing, positioning and joining of unmelted fibers, wind-by-wind. An “envelope” is the outer surface or shell of an imaginary three-dimensional solid object. Once the envelope is completed, it can be used in various ways, for example: it can remain hollow for a functional or decorative purpose; it can be passed to post-processing by another process and system; it can be filled with a filling material; or it can serve as a mold. Some printing methods may involve simultaneous building the envelope and processing or filling it. The term “envelope” may also relate herein to a part of the complete envelope that has been printed so far, which will be clear according to the context. The terms “complete envelope” and “partial envelope” will be occasionally used below to explicitly distinguish between an envelope during printing and an envelope whose printing has been completed.

The envelope is preferably printed upon a turntable that rotates around an axis, or from a turntable that rotates around an axis. Terms such as “vertical”, “up”, “above”, “below”, “under”, or “on top of” relate to directions parallel to the axis, while terms such as “lateral” or “horizontal” relate to directions that are substantially parallel or slightly inclined with respect to the turntable's plane, irrespective of the actual direction of the axis with respect to the ground. A segment of material being positioned “next to” or “proximate to” a wind of material is meant to be positioned in contact with and substantially parallel to the wind, and can be positioned above, below or at any angle on the side of the wind.

A “fiber” is a long continuous mass of a build material selected for printing the envelope. Typically, a fiber may be supplied from a material store, such as a spool or an extruder. A “wind” is a complete loop of fiber that forms part of the printed envelope, such as a loop formed in the course of a complete revolution (360 degrees) of a turntable. A “source fiber” is a fiber coming out of a material store, while a “build fiber” is a fiber dispensed by a printhead; the build fiber may be identical in its cross section and properties to the source fiber, or the cross section and/or properties may be modified by a preprinting stage, that is performed either by a preprint unit positioned between the material store and the printhead, or within the printhead. In some cases, during the preprint stage several source fibers may be merged to form a single build fiber.

The act of “printing” herein is the controller-controlled incremental process of positioning, dispensing and joining a wind segment of fiber relatively to a previous wind or disposing a segment of fiber on a surface, such as a turntable or a planar surface, according to a three-dimensional model of the built envelope. The controller-controlled positioning of the added segments relatively to the previous winds determines the shape of the printed envelope according to a three-dimensional model of the envelope.

It will be noted that, according to the present printing methods, the fiber supplied from a spool or extruder of a material store to a printhead is not melted by the printhead. Thus, while optionally the fiber supplied from the material store may be subsequently heated toward or during printing for improving its bendability or stickiness, such heating does not melt the fiber segment toward its joining to a previous wind.

“Layer-by-layer printing” is when a wind is substantially planar, preferably formed so that the end point of a fiber segment of the current wind's length is cut to overlap the starting point of the same wind. “Helical printing” is when the fiber is continuously dispensed, and a wind is positioned next to and joined to a previous wind, without cutting each wind. Layer-by-layer and helical printing may be combined; for example, several winds may be helically printed horizontally, forming a spiral, and then the fiber may be cut, and another spiral be printed on top of the previous spiral. “Wind-by-wind printing” relates herein to both layer-by-layer and helical printing.

According to preferred embodiments of the present invention, there is thus provided a printer for wind-by-wind printing of three-dimensional envelopes, the printer including a controller for providing printing commands according to a three-dimensional model of a complete envelope; a turntable for carrying and rotating a partial envelope during printing; and at least one printing module. Each printing module includes at least one material store for providing at least one source fiber; a printhead having a dispenser for dispensing unmelted build fiber and a joiner for joining the dispensed unmelted build fiber to a previous wind of the rotating partial envelope; and a positioner controlled by the controller for positioning the printhead relatively to the previous wind of the rotating partial envelope, for the dispensing and the joining, according to the three-dimensional model of the complete envelope.

One of the printer's material stores may provide a single source fiber, and the build fiber and the single source fiber of the respective printing module are identical by cross section and properties. Alternatively, the printer may include a preprint unit, situated between a material store and a printhead, for modifying the build fiber relatively to the source fiber by at least one of: changing the source fiber's cross section, painting the source fiber, or heating without melting the source fiber. Also, the printhead may include a heater for heating without melting the source fiber.

The printer may include a plurality of material stores that provide a plurality of source fibers, and a merger for merging the plurality of source fibers into a single build fiber. Such plurality of source fibers may include at least two fibers of different properties merged by the merger. Also, the printer may include multiple printing modules that concurrently operate for adding multiple build fiber winds to the partial envelope during a single revolution of the turntable.

Also provided is a method of operating a printer for appending new fiber winds to previous fiber winds in the course of wind-by-wind printing of a three-dimensional envelope according to a three-dimensional model of the complete envelope, the method includes: rotating a partial envelope by a turntable; positioning a printhead proximate to a previous fiber wind at a position determined according to the three-dimensional model of the complete envelope; dispensing unmelted build fiber from the printhead; joining the dispensed unmelted build fiber to the previous fiber wind; and repeating the positioning, dispensing and joining steps until a new fiber wind is completed.

The method may further include supplying by a material store a source fiber for being dispensed by the printhead; and modifying the build fiber relatively to the source fiber by at least one of: (i) changing the source fiber's cross section, (ii) painting the source fiber, or (iii) heating without melting the source fiber.

The method may further include supplying by a plurality of material stores a plurality of source fibers and merging the plurality of source fibers into a single build fiber. Additionally, the method may include concurrently operating a second printhead for appending a second fiber wind concurrently with the fiber wind appended by the first printhead.

### BRIEF DESCRIPTION OF THE DRAWINGS

The present invention will be understood and appreciated more fully from the following detailed description, taken in conjunction with the drawings, in which:

FIG. 1A is a block diagram describing an exemplary printing system.

FIG. 1B is a block diagram describing an alternative exemplary printing module.

FIG. 2A is a schematic illustration of an exemplary printer.

FIGS. 2B-2C are schematic illustrations of exemplary robotic arms.

FIGS. 2D-2G are schematic illustrations of top views of exemplary printers.

FIGS. 3A-3B are schematic illustrations of exemplary fiber cross sections.

FIG. 4 is a schematic illustration of a process of wind-by-wind printing.

FIG. 5 is a schematic illustration of a preprinting process.

FIG. 6 is a schematic illustration demonstrating the advantages of fiber shaping.

FIG. 7 is a schematic illustration of a side view of multi-wind printing.

FIG. 8 is a schematic illustration of a merger.

FIG. 9 is a schematic illustration of a variety of fiber merging options.

FIG. 10 is a schematic illustration of a side view of an envelope segment.

FIGS. 11-13 are schematic illustrations of side views of exemplary printing processes.

FIG. 14 is a schematic illustration demonstrating the operation of a bender.

FIG. 15 is a schematic illustration elaborating on printing speed.

FIG. 16A is a flowchart depicting an exemplary printing process.

FIG. 16B is a flowchart depicting exemplary operation of a printing module.

FIG. 16C is a flowchart depicting exemplary operation of a printer having three printing modules.

FIGS. 17A-17C are schematic illustrations of exemplary casting of shaped structures.

FIGS. 18A-18D are schematic illustrations of exemplary portion-by-portion pouring.

FIG. 19 is a flowchart describing an exemplary portion-by-portion casting process.

FIG. 20 is a schematic illustration of an exemplary slow-pouring process.

FIGS. 21A-21G are schematic illustrations of powder-supported casting.

FIG. 22 is a flowchart depicting an exemplary powder-supported casting process.

FIGS. 23A-23B are schematic illustrations of exemplary hanging turntables.

FIGS. 24A-24H are schematic illustrations depicting concurrently printing a mold and casting into the printed mold.

It will be noted that throughout the attached block diagrams and flowcharts, some units or steps that are optional are often drawn using dashed lines.

### DETAILED DESCRIPTION

### Printing System

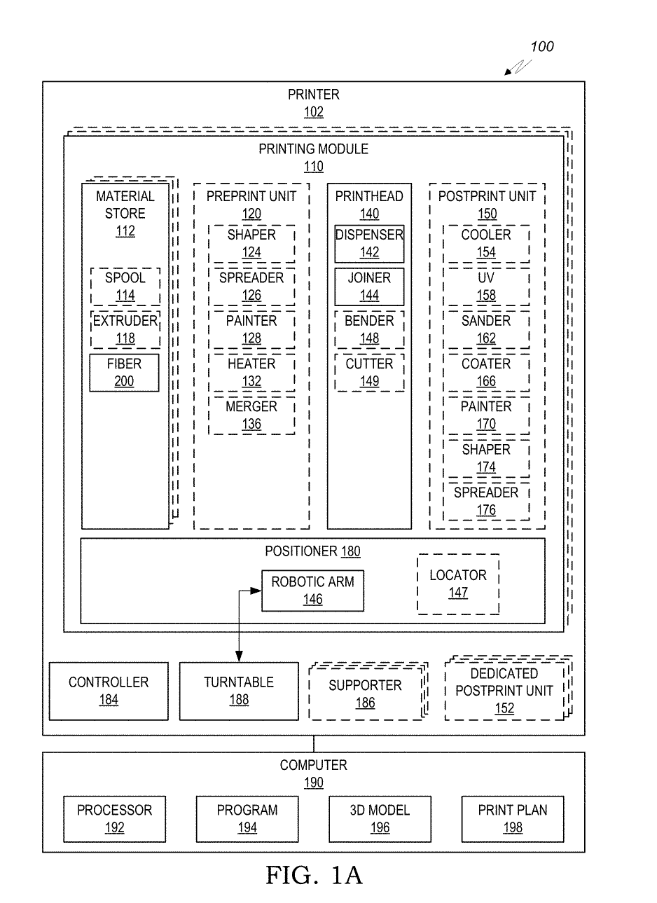

Reference is made to FIG. 1A, which is a block diagram schematically depicting printing system 100 according to an embodiment of the present disclosure. Printing system 100 includes computer 190 whose processor 192, executing printing program 194, transforms a three-dimensional model 196 of an envelope or an imaginary three-dimensional body enclosed by the envelope, into a print plan 198 to be executed by printer 102 for printing a three-dimensional object. Print plan 198 comprises a series of instructions for printing the envelope defined in or derived from the three-dimensional model 196, by printing module 110, as depicted below.

Printer 102 includes a controller 184, one or more of printing module 110, preferably a turntable 188, optionally one or more of supporter 186, and optionally one or more of dedicated post print unit 152. Controller 184 receives the print plan 198 from computer 190 and preferably retains a copy of the print plan 198, and controls the operation of all units of all printing modules 110, and also the operation of turntable 188, optional supporter(s) 186 and optional dedicated post print unit(s) 152, in order to print the envelope according to the three-dimensional model 196. In some embodiments, controller 184 may receive just the three-dimensional model 196 and transform it by itself to a print plan 198, and then further control the printing process. Printing module 110 includes printhead 140 and positioner 180 for dispensing, positioning and joining winds of fiber 200 supplied from one or more of material store 112, next to previous winds, under the control of controller 184 in accordance with the print plan.

Turntable 188 preferably serves as a base upon which the printed envelope is situated during printing, and is included in several preferred embodiments described below, for increasing the printing speed, both when cooperating with a single or with a plurality of printing modules 110. When turntable 188 is included, controller 184 controls the operation of turntable 188 in cooperation with robotic arm 146 of each printing module 110, to offer the functionality of positioner 180 of each printing module 110 as described below.

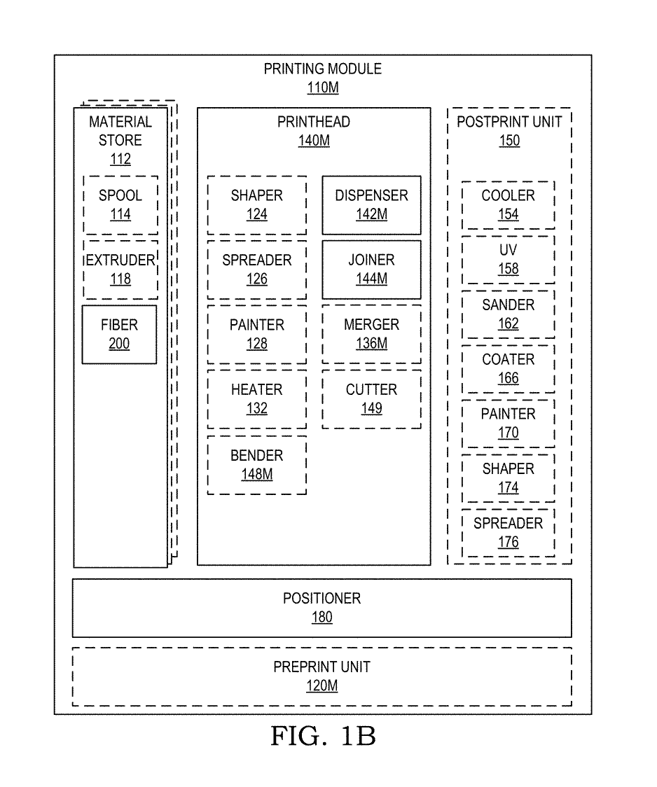

One or more of supporter 186 is optionally included to support larger envelopes during printing, and especially to counter-balance lateral forces that may develop during lateral printing, where a wind is dispensed and joined horizontally to a pervious wind. Supporter 186 is preferably manipulated by a robotic arm and controlled by controller 184 similarly to printhead 140 as will be described below. Where multiple printing modules 110 are used, such as in the example of FIG. 2E, supporter 186 may become redundant and may be eliminated from the design of printer 102.

One or more dedicated post print unit(s) 152 are optionally included separately from printing module(s) 110 to perform all or part of the post print tasks of the post print unit(s) 150 of the printing module(s) 110 described below, thereby allowing to eliminate the post print unit(s) 150 or reduce their functions.

Fiber 200 is a long continuous mass of a build material selected for printing the envelope. The length of the fiber to be continuously supplied by material store 112 is preferably at least sufficient for wind-by-wind printing of the entire envelope. The material of fiber 200 is selected by the desired mechanical, thermal and functional properties of the finished envelope; by being suitable for printing the envelope using the printing method taught by the present disclosure; by cost considerations; and by handling and environmental considerations. Examples for build materials usable for fiber 200 include plastics, metals, alloys, rubber, composite materials, fiberglass and wax. In an example of a fiber having a rectangular cross section, the width and height of the fiber, measured at the fiber's cross section, are selected according to the size and shape of the envelope, the required mechanical properties and surface quality, the printing speed, and the build material, under considerations such as: a higher fiber implies faster printing yet lower surface quality; a wider fiber implies stronger build yet it is less bendable, or even unusable, in sharper turns in the envelope lateral cross section, depending on the properties of the build material and sometimes also on the fiber temperature during printing. Fiber 200 is preferably supplied to printhead 140 from either a spool 114, such as a reel of fiber mounted within material store 112, or is produced on-the-fly by an extruder 118 that is included in material store 112 and is devised to convert a raw material, that is not in fiber form, into fiber 200.

Positioner 180 is a device controlled by controller 184 for positioning printhead 140 at a desired point relatively to a previous wind toward dispensing a new segment of fiber and joining it to the previous wind. Positioner 180 includes a robotic arm 146 for positioning printhead 140 at a desired spatial point and inclination, and preferably cooperates with turntable 188 that revolves the built envelope, or the entire printing modules 110, for increased printing speed. Thus, the term “positioning” of a segment of fiber next to a previous wind of the envelope is to be interpreted in relative terms, i.e. the added segment positioned relatively to a previous wind of the envelope, irrespective of whether the envelope rests on a stationary base or revolves upon turntable 188. Optional locator 147 measures the actual position of printhead 140 and reports it to controller 184, for subsequently correcting errors in the placement of robotic arm 146 or for activating shaper 124 and/or spreader 126 to dynamically-adapt the height of the currently-printed wind in order to correct height errors accumulated during printing of previous winds.

It will be noted that when printer 102 having a turntable 188 includes multiple printing modules 110, all robotic arms 146 of the respective printing modules 110 are synchronized by controller 184 with turntable 188, to ensure effective operation of each positioner 180 for printing the envelope according to three-dimensional model 196.

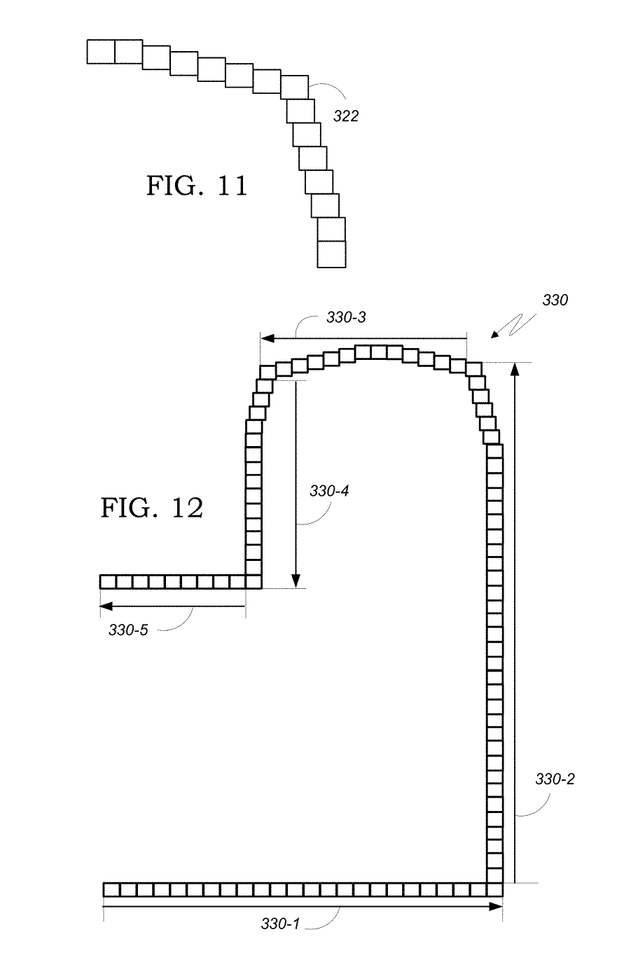

Printhead 140 includes dispenser 142 that is devised to receive a build fiber either from material store 112 or preprint unit 120 and dispense a segment of build fiber at a desired point, determined by positioner 180 under commands received from controller 184 according to the three-dimensional model 196 of the printed envelope, next to a previous wind, and press it against the previous wind, or, when beginning a new print job, dispense a segment of build fiber upon a surface, such as turntable 188 or a stationary base. For some build materials, the currently-dispensed build fiber segment, at the printing temperature, may sufficiently adhere to a previous wind. In other cases, the currently-dispensed fiber segment is joined to a previous wind by joiner 144, that is a unit that heats and/or applies or sprays an adhesive (e.g. for plastic or metallic build material) or executes soldering or welding (e.g. for metallic build material). Bender 148 is optionally included, to horizontally bend the fiber according to the curvature of the instant lateral cross section of the printed envelope. Cutter 149 is devised to cut the fiber at the end of the printing job, and also, in layer-by-layer printing, it cuts the fiber at the end of a wind, where joiner 144 may then optionally join the end of the wind to the beginning of the same wind. It will be noted that such joining of end-to-beginning contacts may be obviated by horizontally distributing such contacts among consecutive winds, as will be further elaborated with reference to FIG. 10 below.

Preprint unit 120 is optionally positioned between material store 112 and printhead 140, to optionally prepare fiber 200 coming out of material store 112 for printing by printhead 140. When preprint unit 120 changes at least one property of the fiber, the fiber coming out of material store 112 is called herein “source fiber” while the fiber provided by preprint unit 120 to printhead 140 is called “build fiber”. Shaper 124 is optionally used to selectively and dynamically change the cross section of the fiber provided by material store 112 to printhead 140 by applying subtractive methods, such as shaving or milling (for harder materials) or scraping or rolling (for softer materials). Shaper 124 may turn a rectangular fiber cross section into a trapezoidal cross section for smoother printing surface of the currently-printed envelope segment thus allowing using a fiber with a taller cross section for higher printing speed. Another optional use of shaper 124 is for dynamically varying the height of a wind in order to correct height errors accumulated in the course of printing a plurality of layers, or, in heliacal printing, for making the first wind laid on the turntable inclined so that subsequent winds can be smoothly placed on top of each other. Spreader 126 is optionally included, to replace or cooperate with shaper 124, by applying a slanted layer of a quick-hardening material to the side of, or on top of the fiber. If the material applied by spreader 126 is a curable polymer, spreader 126 preferably includes a UV source for hardening the applied material. It will be noted that a material store 112 using an extruder 118 having a controllable variable die may obviate the need for some or all of the functions of shaper 124 and/or spreader 126.

Painter 128 may be used to paint the outer surface of fiber 200, hence the outer surface of the built envelope; using one or several color inkjet heads within painter 128 may allow producing an envelope showing graphics, text and pictures on its surface. Heater 132 is optionally used for preheating without melting fiber 200 toward printing, if such preheating makes the build material more bendable (thus allowing wider fibers) or for better joining the dispensed fiber to a previous wind.

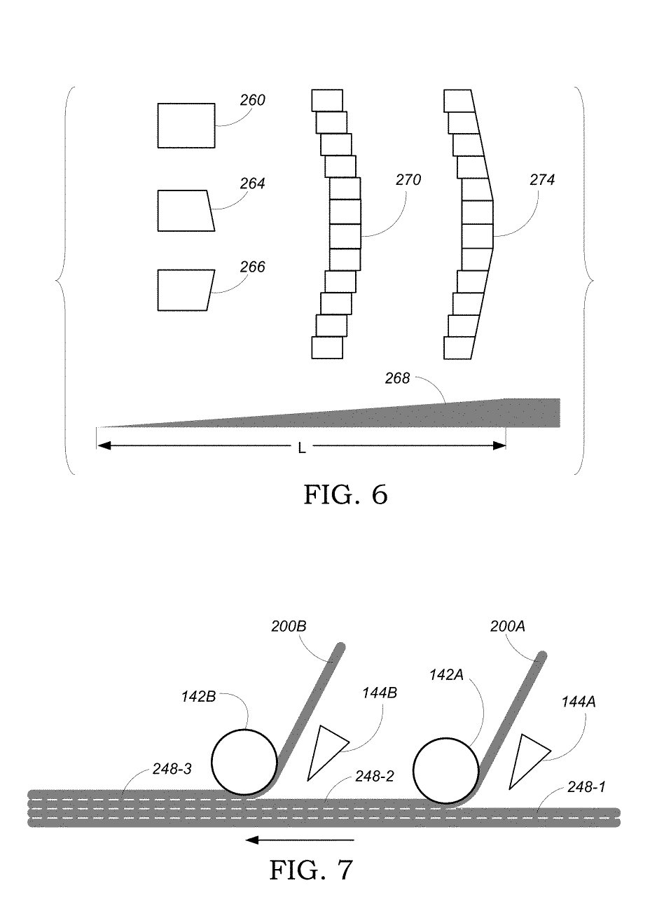

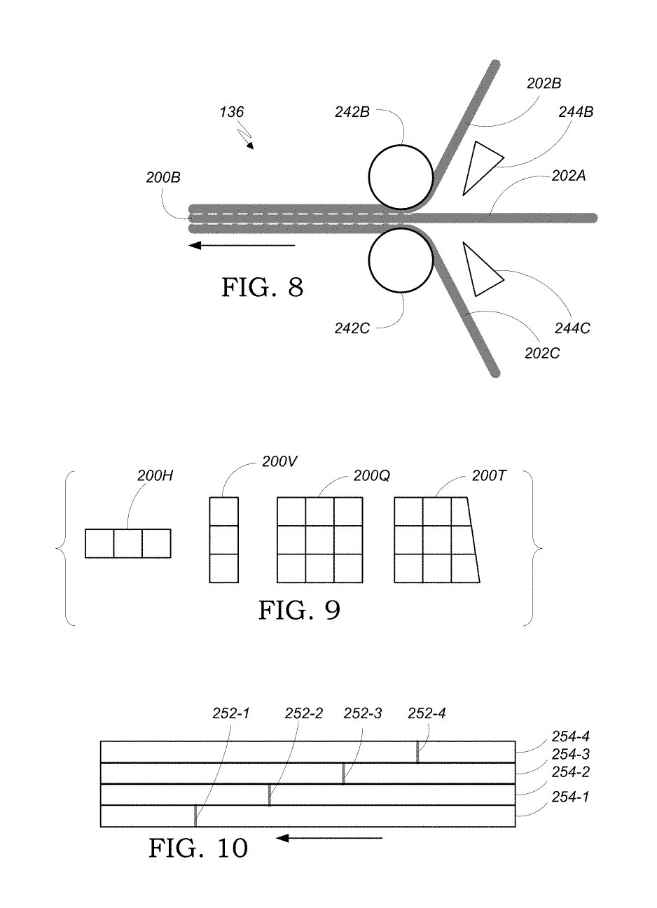

In some cases, it may be advantageous to merge several source fibers, supplied by several material stores 112, into a single build fiber dispensed by printhead 140. Such merging may provide higher printing speed (for vertical merging) or a thicker envelope while maintaining high bendability of the fiber. Merger 136 is used to merge several fibers into one, as will be further elaborated with reference to FIGS. 8-9 below.

Post print unit 150 is optionally placed following printhead 140, for further processing the fiber that has just been joined to a previous fiber. Cooler 154 may cool the material previously heated toward or during the printing process. UV light source 158 may cure materials or adhesives just dispensed and joined by printhead 140. Sander 162 may polish the envelope surface, while coater 166 may apply or spray a layer of functional, protective, polishing or decorative material. Painter 170 may replace or supplement painter 128 of preprint unit 120 in adding color, graphics, texts and/or pictures to the finished envelope. Shaper 174 and spreader 176 may optionally complement or replace some or all functions of shaper 124 and spreader 126 of preprint unit 120.

FIG. 1B schematically depicts printing module 110M having an alternative design t of printing module 110 of FIG. 1A, where some or all of the components of preprint unit 120 are integrated into printhead 140M. Thus. Instead of preparing the fiber for printing on its travel from material store(s) 112 to printhead 140, printhead 140M perform a more complex and sophisticated printing operation. Specifically, dispenser 142M, joiner 144M, merger 136M and bender 148M may cooperate to dispense, join, merge and bend at once several fibers, which offers advantages of speed, bendability and precision. It will be appreciated that when several source fibers are horizontally merged by printhead 140M forming a curved segment in the instant wind, the length of the source fibers received from the respective material stores 112 will be different from each other. A preprint unit 120M may optionally still be positioned between material store(s) 112 and printhead 140M, to accommodate selected components of preprint unit 120 of FIG. 1A that are not integrated into printhead 140M.

### Basic Printer

FIGS. 2A and 2B are schematic illustrations of printer 102, which includes a single printing module 110 (see FIG. 1A). The figures show a snapshot in the course of printing an envelope 104, that is shown in the present figure, for simplicity, as a cylindrical envelope. Turntable 188 rotates clockwise around axis 106, which causes envelope 104 to rotate similarly. Printhead 140 receives fiber 200 from material store 112 and uses dispenser 142 to dispense the fiber on top of a the previous wind of envelope 104. Printhead 140 is supported by base 146-1, column 146-2 and rod 146-3, moving up (in Z direction) by vertical actuator 146A and laterally (changing r) by horizontal actuator 146H, under the control of controller 184. It will be noted that base 146-1, column 146-2, rod 146-3, horizontal actuator 146H and vertical actuator 146A serve as simplified representatives of parts of robotic arm 146 of FIG. 1A. It will be appreciated that while the envelope shown in FIG. 1A is cylindrical, a rich variety of envelope shapes can be printed by cooperation of turntable 188 with robotic arm 146, under the control of controller 184 following instruction included in print plan 198 received from computer 190 (FIG. 1).

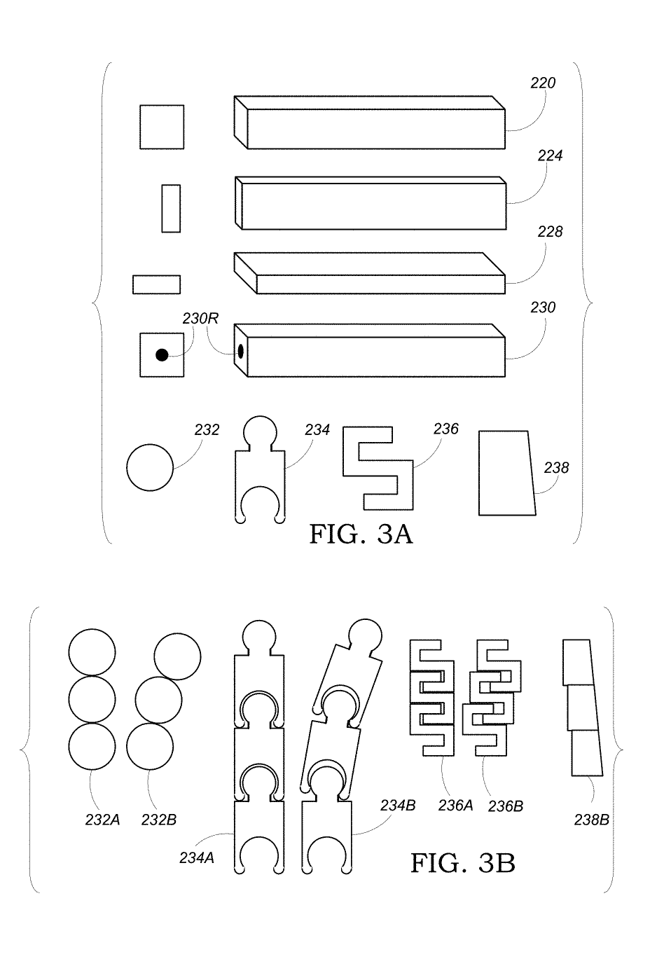

It will be noted that a wind is completed upon a complete revolution (360 degrees) of the turntable. When printing is made vertically and helically, a complete revolution of the turntable is associated with the printhead 140 raising by the height of the fiber, where the raising is made gradually during the rotation. Thus, in the example of the cylindrical envelope of FIGS. 2A and 2D, a typical wind is slightly inclined, relatively to the face of turntable 188. For a smooth printing process, preferable the first wind, which is dispensed on the surface of turntable 188, is made inclined, by preprint unit 120 or printhead 140M, or by a controllable variable die of extruder 118 (both not shown in FIGS. 2A-2B), shaping the cross section of the build fiber to start with zero height and end, at the complete end of the first revolution, at a height that equals the normal height of the fiber. See inclined wind 268 in FIG. 6 for further discussion.

FIG. 2C schematically illustrates a variation of the arrangement shown in FIG. 2B, demonstrating a more sophisticated robotic arm 146, wherein a second column 146-2 and a second vertical actuator 146B allow to print winds that extend into the inner part of the previously built envelope 104 of FIG. 2A. The examples of the robotic arms in FIGS. 2B and 2C are highly simplified and illustrative only, and it will be appreciated that including more sophisticated robotic arms 146 known in the art for directing printhead 140 may allow printing fairly complex envelopes.

FIG. 2D schematically illustrates a top view of printer 102 of FIGS. 2A-2C above, emphasizing turntable 188, envelope 104, printing module 110 and controller 184.

### Multi-Module Printer

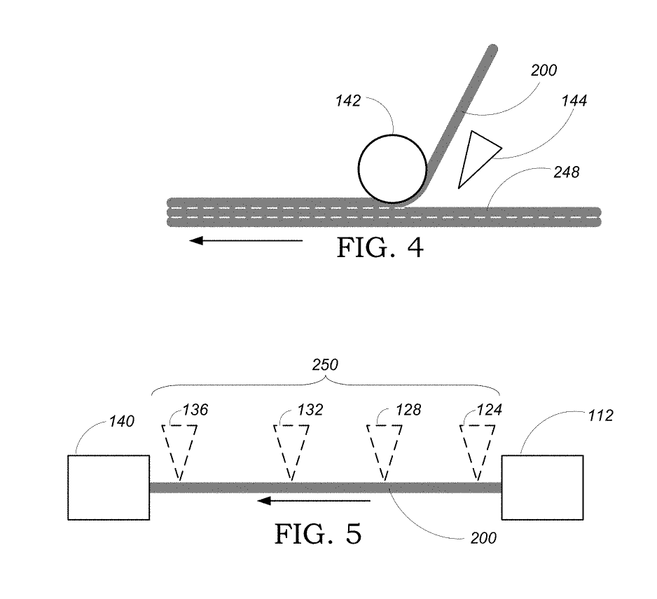

FIG. 2E schematically illustrates a top view of a multi-module printer, wherein a single envelope 104 positioned on top of a single turntable 188 is simultaneously printed by multiple printing modules, represented in the illustration by printing module 110A, printing module 110B and printing module 110C, operating under the control of controller 184. Each complete revolution of turntable 188 ends up with multiple (three in the present example) winds dispensed and joined to previous winds, as will be further elaborated with reference to FIG. 7 below.

FIG. 2F schematically illustrates a top view of a printer that includes a single printing module 110 and a supporter 186. Supporter 186 is devised to stabilizes envelope 104 during printing, and specifically to counterbalance lateral forces applied by printing module 110 in the course of laterally joining winds to previous winds. For positioning and operation of supporter 186, supporter 186 preferably includes a robotic arm controlled by controller 184.

FIG. 2G schematically illustrates a top view of a printer that includes multiple printing modules represented by printing module 110A and printing module 110B, and a separate, dedicated post print unit 152 that performs all or part of the post print tasks of the respective post print units 150 of printing module 110A and printing module 110B, thereby allowing to eliminate or reduce the functions of these post print units. It will be noted that, in some embodiments, dedicated post print unit 152 may perform operations, for example painting, on several previously-printed winds at once.

FIGS. 2E and 2G also demonstrates that when several functional units are simultaneously used during printing, the need for a dedicated supporter, such as supporter 186 of FIG. 2F, is obviated.

### Fiber Cross Sections

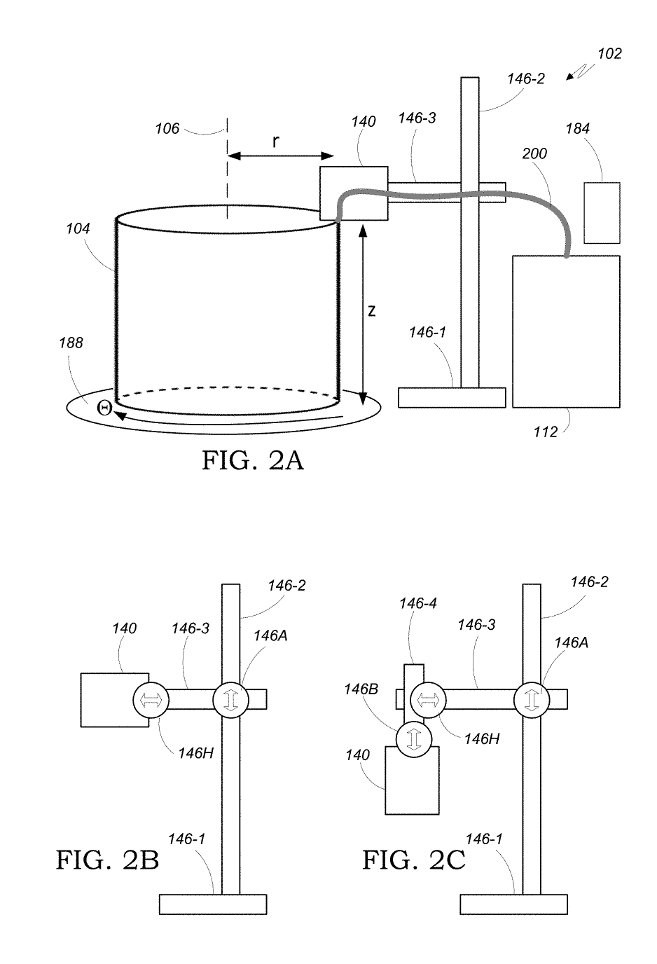

Reference is now made to FIGS. 3A-3B. Preferably but not necessarily, fiber coming out of material store 112 has a rectangular cross section, such as square fiber 220, tall rectangular fiber 224 or wide rectangular fiber 228. Square fiber 220 is suited for general purpose printing. Tall rectangular fiber 224 offers faster printing of tall envelopes, while wide rectangular fiber 228 offers thicker envelopes with smoother surface but may be in conflict with tough or brittle materials that are less bendable. Fiber 230 demonstrates an option to provide, either from spool 114 or from extruder 118, reinforced fiber that includes a reinforcer 230R. Thus, for example, a plastic or wax fiber coming out of material store 112 may include a metal wire core as reinforcer 230R, that may substantially improve the mechanical properties of the finished envelope.

It will be noted that cross sections of source fibers coming out of material store 112, that are not rectangular, are also possible, and may sometimes be advantageous. A round fiber 232 may be sufficient for some applications, allowing joining winds at various angles, as demonstrated by cross sections 232A and 232B. Interlocking profiles, such as interlocking fiber 234 and interlocking fiber 236 can be also joined in various angles, as demonstrated by cross sections 234A, 234B, 236A and 236B. A trapezoidal fiber 238 may sometimes be the preferred choice, if an extruder 118 with a controllable variable die controlled by controller 184 is included in material store 112, which may provide better surface quality in inclined parts of an envelope, as demonstrated by cross section 238B.

### Wind-by-Wind Printing

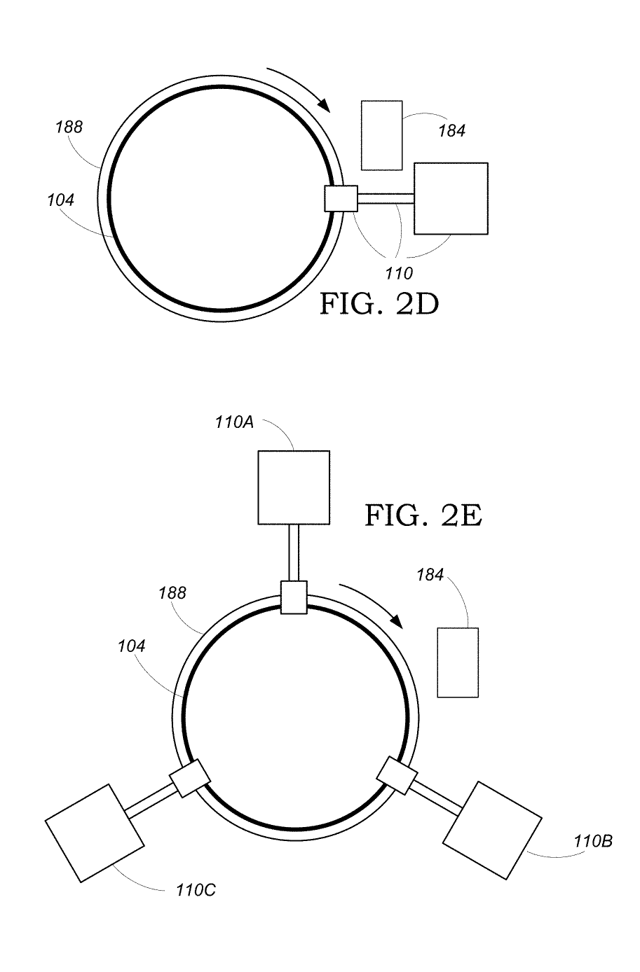

FIG. 4 schematically illustrates a side view of a process of wind-by-wind printing. Previous wind 248 already forms part of the built envelope. Fiber 200 is dispensed and pressed by dispenser 142 on top of previous wind 248, while previous wind 248, together with the entire built envelope, is moving to the left with turntable 188. Joiner 144, such as an adhesive sprayer, a solder, etc., according to the build material and printing temperature, ensures that the portion of fiber 200 currently pressed against previous wind 248 joins the previous wind 248, thus adding another wind to the currently-built envelope.

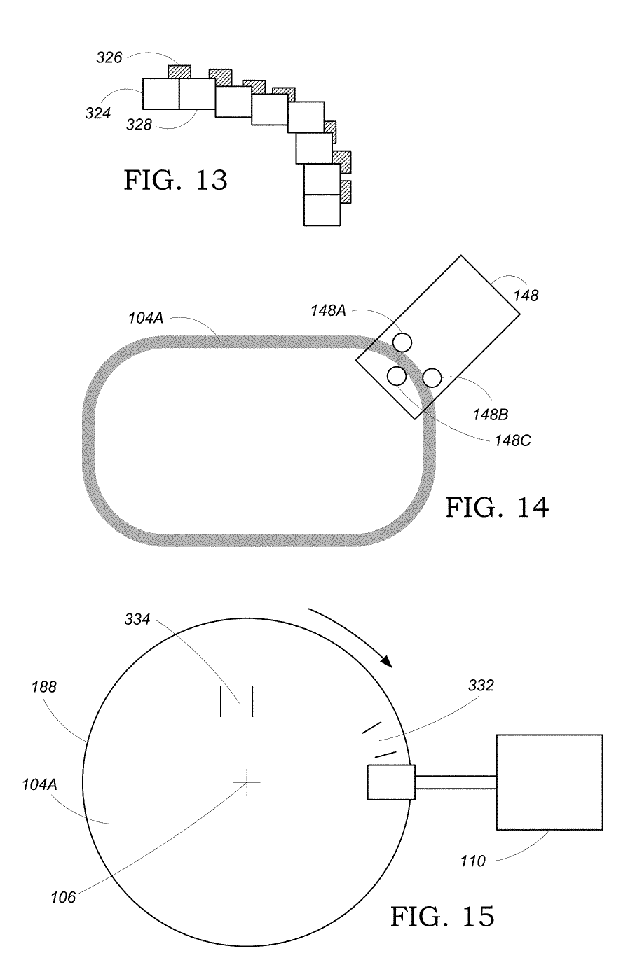

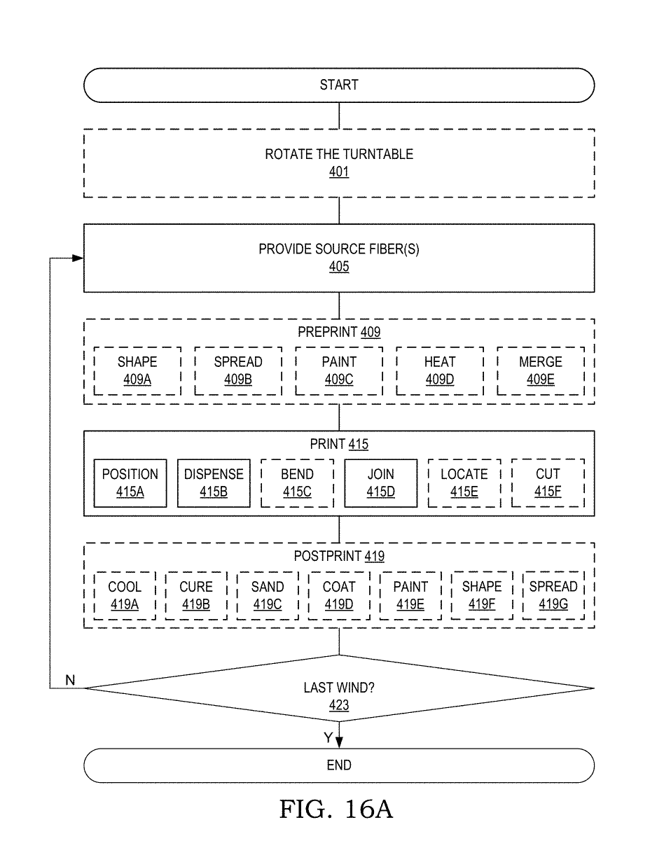

It will be noted that the illustration of FIG. 4, when interpreted as a top view, teaches adding a wind laterally, as may be desired in some building processes, either for printing a thicker envelope, or for printing a segment in the envelope that is inclined by more than 45 degrees, as will be further elaborated with reference to FIGS. 11-12 below.

### Preprinting

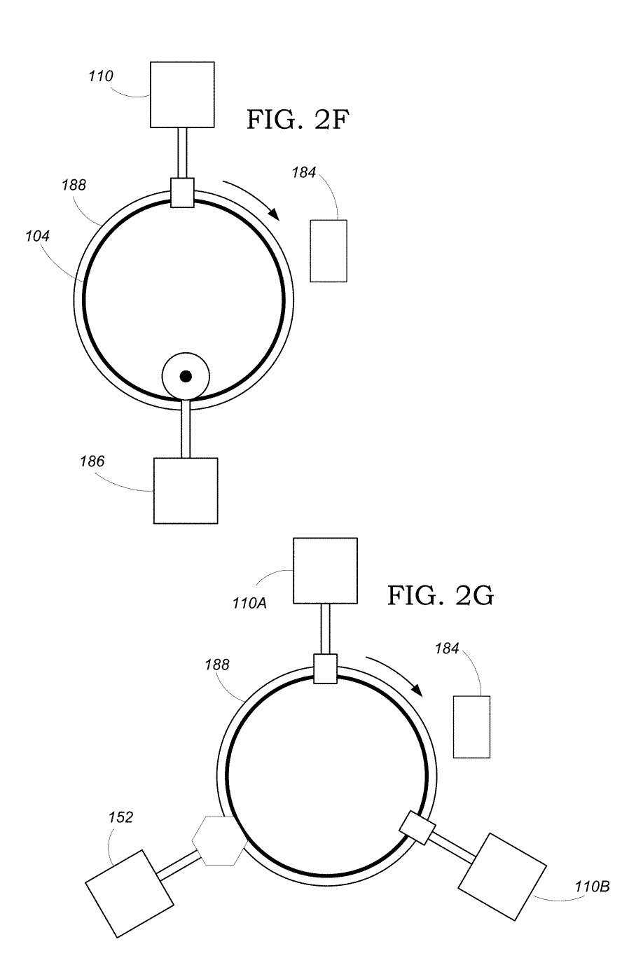

FIG. 5 schematically illustrates optional preprint processes by preprint unit 120, for preparing fiber 200, on its travel from material store 112 to printhead 140, for improved printing by printhead 140. Preprint region 250 accommodates zero or more of shaper 124, painter 128, heater 132, or merger 138, for performing the preprint processes depicted above with reference to FIG. 1A.

It will be noted that while a single build fiber 200 may enter printhead 140, multiple source fibers may come out of several material stores 112, and be merged by merger 136 into the single build fiber entering printhead 140, as will be further elaborated with reference to FIGS. 8-9 below.

### Inclined Winds and Trapezoidal Build Fibers

FIG. 6 demonstrates the advantages of selectively shaping the fiber for forming an inclined wind, or selectively shaping fibers into having a trapezoidal cross section rather than a rectangular cross section. The inclined wind and/or the trapezoidal cross section are preferably formed by one of the following methods: (a) shaper 124 is activated to shave the excess material from a rectangular fiber; (b) spreader 126 is activated to add and harden a slanted layer of material, such as a curable polymer paste, to the rectangular fiber; or (c) a controllable variable die of extruder 118 included in material store 112 produces the desired varying fiber height or trapezoidal cross section.

Inclined fiber segment 268 may be advantageous in helical printing, and is shown in side view, where “L” is the length of the first complete wind that is dispensed on the surface of turntable 188, for an exemplary case of printing an envelope that will remain open at the bottom. On the right hand side of inclined wind 268, the height of the fiber starts from zero, and is gradually increased, until, at the end of the first wind, it reaches the full height of the fiber, and remains at this height for subsequent winds.

Rectangle 260, trapezoid 264 and trapezoid 266 represent cross sections that are selectively produced by employing either shaper 124 or spreader 126 of preprint unit 120 or extruder 118 (see FIG. 1A), to selectively supply fiber with the desired cross section. Structure 270 demonstrates a cross section of an envelope segment, that is built of twelve winds having only rectangular cross sections such as rectangle 260. As can be seen, structure 270 has a staggered outer surface. In contrast, structure 274 that selectively mixes winds having cross sections of rectangle 260, trapezoid 264 and trapezoid 266, demonstrates an outside surface that is much smoother than the surface in structure 270. It will be appreciated that by gradually varying the angle of the slanted side of the trapezoid, printing envelope segments that have smooth vertically convex or concave cross section is made possible. It will also be appreciated that when the built envelope is to serve as a mold, it is the inner face of the envelope that needs to be smooth, and the slanted side of the trapezoids will move accordingly, for example to the left hand side of the trapezoids in structure 274.

### Multi-Wind Printing

Multi-wind printing is when more than one wind is added to the envelope, vertically and/or horizontally, during a single revolution of turntable 188. FIG. 7 schematically illustrates, from a side view, multi-wind printing, where multiple printing modules, such as printing module 110A and printing module 110B of FIG. 2E, simultaneously dispense and join multiple winds on top of each other. Thus, dispenser 142A and joiner 144A of printing module 110A dispense and join fiber 200A on top of previous wind 248-1 to form wind 248-2, followed, within the same complete revolution of turntable 188, by dispenser 142B and joiner 144B of printing module 110B dispending and joining fiber 200B on top of wind 248-2 to form wind 248-3. The advantage of such vertical multi-wind printing, is in increasing the printing speed (in the present example, up to doubling the printing speed).

It will be noted that when FIG. 7 is interpreted as a top view, FIG. 7 teaches lateral multi-wind printing, where wind 248-3, wind 248-2 and wind 248-1 are dispensed and joined horizontally, next to each other. The advantage of such lateral multi-wind printing, is in printing, at a normal printing speed, a sufficiently thick and strong envelope, while using thin fibers that are sufficiently-bendable in sharper turns even with tough and brittle build materials (wind curvature is not demonstrated in FIG. 7).

It will be appreciated, that, with a sufficient number of printing modules 110, mufti-wind printing may simultaneously add both vertical and horizontal cross sections. For example, a printer 102 having nine printing modules 110 may be used to add, in the course of a single complete revolution of turntable 188, a matrix of 3×3 winds.

### Merging Fibers During Preprinting

When employing merger 136 during the travel of multiple source fibers from multiple material stores 112 to printhead 140 (FIG. 5), merger 136 merges the multiple source fibers into a single wider and/or taller build fiber to be dispensed by printhead 140.

In some cases, it may be advantageous to mix source fibers of different mechanical and/or thermal properties, and then material stores 112 supply source fibers of such different properties, and merger 136 merges such source fibers of different properties into a single build fiber.

FIG. 8, with reference also to FIG. 9, schematically illustrates a top view of a merger 136, showing roller 242B and roller 242C, in cooperation with joiner 244B and joiner 244C, respectively, merging source fiber 202B and source fiber 202C with source fiber 202A into build fiber 200B that has a wide rectangular shape as demonstrated by the cross section of wide rectangle 200H of FIG. 9. When referring to FIG. 8 as a side view, merger 136 produces build fiber 200B that has a tall rectangular shape as demonstrated by the cross section of tall rectangle 200V of FIG. 9. Such merging may be formed also by merger 136M of printhead 140M of FIG. 1B. Combining vertical and horizontal merging, merger 136 or merger 136M may produce a build fiber 200B with a larger cross section both horizontally and vertically, having a cross section such as large square 200Q of FIG. 9. By using one or more of shaper 124/124M and/or spreader 126/126M for selectively turning the rectangular cross sections of the source fibers into trapezoidal cross section, larger, non-rectangular build fibers, having a cross section such as large trapezoid 200T, can be produced.

Horizontal merging of a plurality of source fibers may produce a build fiber with a predefined horizontal curvature, by supplying the source fibers at slightly-different rates and/or at different temperatures. Such laterally-curved build fibers that are fitted to the curvature of the respective envelope segment, may facilitate printing thicker envelopes using tough or brittle build materials. Such horizontal merging may be formed, for example, by either merger 136 of preprint unit 120 of FIG. 1A, or by merger 136M of printhead 140M of FIG. 1B.

Generally speaking, both merging several fibers into one, as depicted in FIGS. 8-9, and using multiple printing modules 110/110M, as depicted in FIG. 2E and FIG. 7, offer advantages of increased printing speed and better handling of horizontal curvatures using wide fibers made up of tough or brittle build materials, and the choice between merging or multi-unit printing is a matter of design, cost and performance considerations.

As noted above, it will be appreciated that when multiple fibers are provided by multiple material stores 112, and/or multiple build fibers are dispensed by multiple printing modules 110/110M, different fiber materials having different properties may be used for different source fibers, based on the required properties of the finished envelope and on cost considerations.

### Distributed Seams in Layer-by-Layer Printing

FIG. 10 schematically illustrates a side view of an envelope segment that includes four layers 254-1 to 254-4 built by a layer-by-layer method, i.e. where an end of a wind overlaps the beginning of the same wind. Such beginning-end point will be referred to herein as a “seam”. Seams 252-1 to 254-4 are preferably horizontally distributed, as demonstrated in FIG. 10, rather than forming a vertical line, thereby offering advantages such as: better mechanical properties of the envelope; optionally obviating the need to join, e.g. by applying an adhesive, the two sides of the seam; making the seams less visible; and allowing time for the printhead to raise vertically toward printing the subsequent wind.

### Vertical and Horizontal Printing

Printhead 140 employs dispenser 142 and joiner 144 for joining a segment of fiber to a previous wind, typically either vertically or horizontally.

FIG. 11 schematically demonstrates, by presenting a cross section of several winds, a printing process that includes a transition from vertical printing to horizontal printing, which preferably happens when the printed envelope direction turns from mostly vertical to mostly horizontal. Thus, while the winds below rectangle 322 are joined vertically to their respective previous winds, the winds following rectangle 322 are joined horizontally to their respective previous winds.

FIG. 12 further extends and generalizes the combined vertical and horizontal printing method demonstrated in FIG. 11, with the axis of turntable 188 assumed to reside outside and on the left hand side of the drawing. Envelope segment 330, shown as a vertical cross section composed of many rectangular cross sections of fiber winds, is initially printed by dispensing, positioning and joining fiber winds on turntable 188 away from the axis, as demonstrated by horizontal printing segment 330-1. Then, winds are dispensed and joined on top of each other, as demonstrated by vertical printing segment 330-2. In horizontal printing segment 330-3 winds are dispensed and joined horizontally toward the axis. Vertical printing segment 330-4 is made of fiber winds dispensed and joined downwards, i.e. a wind is joined to its predecessor that is positioned above it, while horizontal printing segment 330-5 is another segment made of winds dispensed and joined toward the axis. It will be noted that a structure such as the one of FIG. 12 requires a sophisticated robotic arm 146 for allowing printhead 140 to effectively reach the respective printing positions throughout the printing of envelope segment 330.

### Printing Metallic Envelopes

A metallic envelope can be printed by using a metallic fiber, for example a copper or aluminum fiber. Joining metallic winds can be made by joiner 144/144M soldering or welding the winds to each other, which may be difficult and slow-down the printing process, or by applying an appropriate metal-to-metal adhesive. In some applications, metal-to-metal adhesives may compromise the properties and quality of the complete metallic envelope. Post processing of the complete metallic envelope by sintering may allow temporarily using an adhesive for joining the winds, and further obtaining a final metallic build of high quality by sintering, provided that the adhesive material properly bonds the winds and does not interfere with the sintering process.

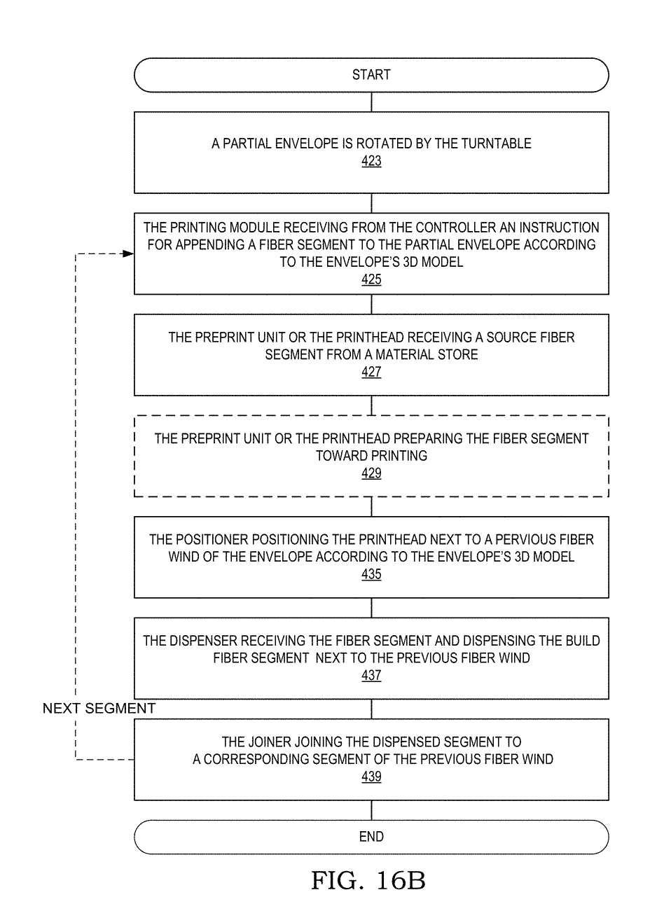

FIG. 13 conceptually illustrates a joining method that applies patches, such as patch 326, for joining adjacent winds, represented by their cross sections such as rectangle 324 and rectangle 328. This concept resembles using an adhesive tape or a chewing gum to externally join two pieces, without introducing a glue onto the contact surface between the pieces. Thus, patches placed externally, as demonstrated by FIG. 13, to temporarily join metallic winds during printing and sintering, may provide an effective alternative to introducing an adhesive between the joined winds, thus potentially be friendlier to sintering, and be removed during the sintering by heat or following the sintering by mechanical and/or chemical methods.

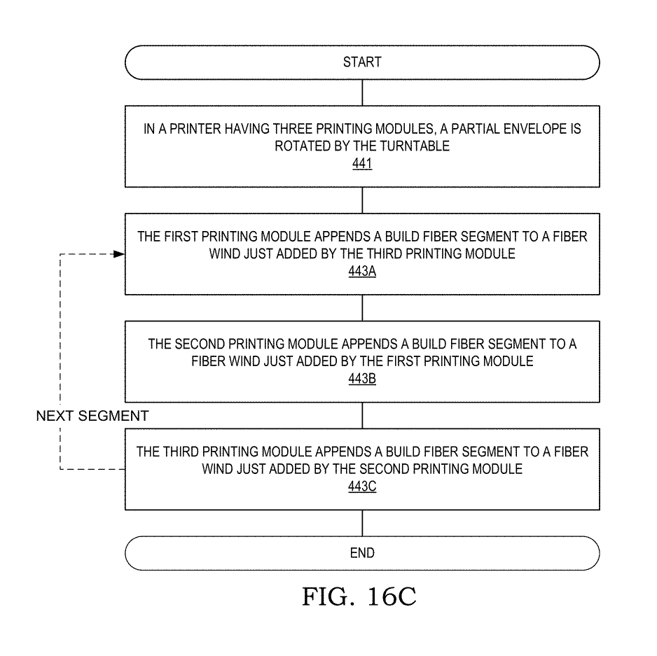

Specifically for metallic fibers, use of a bender 148 that forms part of printhead 140/140M (FIGS. 1A-1B) may prove advantageous, demonstrated by FIG. 14 that shows a top view of bender 148, symbolically represented by rollers 148A-148C, facilitating the printing of a curved segment of envelope 104A. Use of a heater 132 may further facilitate the printing of a curved segments.

### Printing Speed and Turntable Angular Velocity

With reference to FIGS. 1A-1B, printing an envelope is made via cooperation of the operating units of material store(s) 112, preprint unit 120, printhead 140/140M and post print unit 150/150M of all operating printing module(s) 110/110M, as well a optional supporter(s) 186 and optional dedicated post print unit 152. The linear printing speed of a current wind is limited by the slowest one of the operating units listed above.

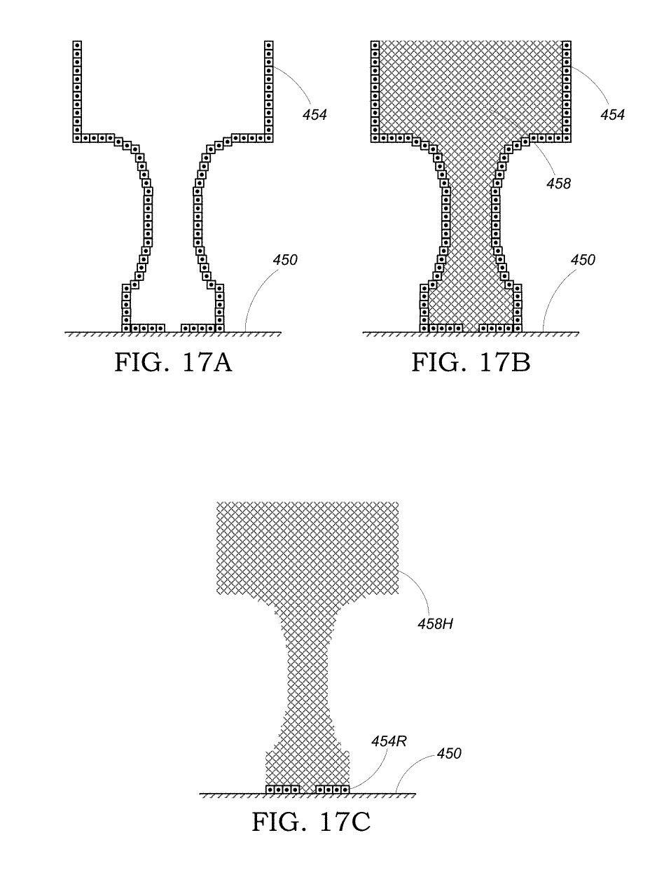

With reference to FIG. 15, it will be noted that a certain linear printing speed by printing module 110 may imply a significantly varying angular velocity of turntable 188; for example, printing wind segment 332 of envelope horizontal cross section 104A, mandates slower maximum angular velocity of turntable 188 than printing wind segment 334, because wind segment 334 is closer than wind segment 332 to the rotation axis 106 of turntable 188.

It will be further noted that when multiple printing modules 110 operate simultaneously (see FIG. 2E), and/or a dedicated post print unit 152 is included in printer 102 (see FIG. 2G), the angular velocity is further limited by the current radial distance from the turntable axis of all operating units. Thus, for complex envelopes, some of the overall envelope printing speed gain of simultaneously operating multiple print modules 110 may be lost, and using mergers instead can prove to provide a faster printing alternative.

### Printing Process

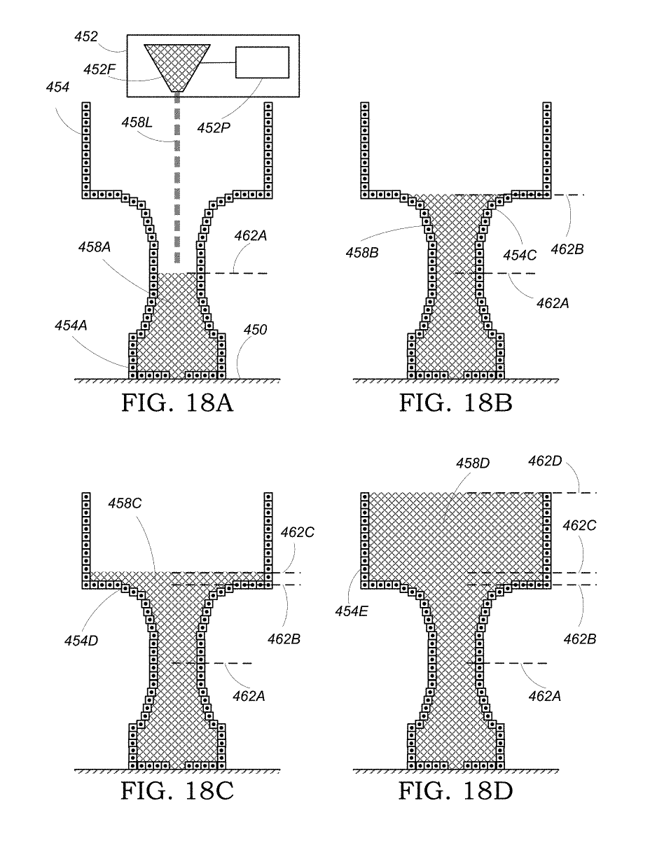

FIG. 16A is a flowchart schematically describing a process of operating a printer 102 of FIG. 1A for printing an envelope wind-by-wind, according to embodiments of the present disclosure. The steps of the process will be described with reference also to FIG. 1A. For clarity, the process below will be initially described for the case of a single printing module 110 having a single material store 112. The more general cases of multiple printing modules and/or multiple material stores per a printing module will be subsequently described.

### A Single Printing Module Having a Single Material Store

In optional step 401 turntable 188, if included in printer 102 (FIG. 1A), is rotated under the control of controller 184. If part of the envelope has already been printed on top of the turntable, the partially-printed envelope rotates with the turntable. In step 405, source fiber 200 is provided by material store 112. If an extruder 118 with a controllable variable die is included in material store 112, step 405 may provide a source fiber that is shaped according to the shape of the intended envelope segment, which may obviate the need for steps 409A-409B below. In optional preprint step 409 the fiber is prepared for printing via one or more of the following sub steps: in optional step 409A the fiber is shaved by shaper 124 for turning a rectangular cross section of the source fiber into trapezoidal cross section, whose slanted side matches the angle of the current envelope segment, or for producing a first inclined wind on top of the turntable for smoother printing of the subsequent winds in helical printing. If the envelope is of a decorative or a functional object, the slanted fiber side preferably faces outwards the envelope, while in case of an envelope of a mold, the slanted side preferably faces inwards. Optional step 409B either supplements or replaces step 409A and is performed by spreader 126 for making the fiber slanted or inclined by adding and hardening a material to a rectangular source fiber. In optional step 409C the outer face of the fiber is painted by painter 128, such as with one or more inkjet heads, which accumulates throughout all winds into colors, graphics, texts and/or pictures showing on the finished envelope face. In optional step 409D the fiber is heated by heater 132 to a controlled temperature below the melting point, for improving its adhesion and/or bendability toward step 415.

In step 415, the build fiber, which is either the source fiber supplied from material store 112, or the processed fiber that has passed one or more of the processes of preprint step 409, is either dispensed by printhead 140 on turntable 188 at the beginning of the printing job, or is dispensed and joined by printhead 140 to a previous wind. Step 415 includes the following sub steps: in step 415A, printhead 140 is positioned by robotic arm 146 at the intended printing point according to print plan 198. In step 415B dispenser 142 dispenses a segment of fiber next to a previous wind (or on the turntable) and in optional step 415C bender 148 bends the segment according to the current horizontal curvature of the printed envelope. In step 415D joiner 144 joins the fiber segment to a previous wind. In optional step 415E, locator 147 locates the actual position of printhead 140 and reports it to controller 184, and, in the case of layer-by-layer printing, step 415F selectively employs cutter 149 to cut the fiber at the end of the current wind, toward printing the next wind.

The just-dispensed fiber may be further processed, via optional post print step 419, by one or more of the following sub steps: in step 419A, cooler 154 reduces the temperature of the just-added material that has been heated by either heater 132 or printhead 140. Optional step 419B uses UV light source 158 for curing and hardening curable polymers applied either by spreader 126 or as an adhesive by joiner 144. Optional steps 419C, 419D, and/or 419E are applied by sander 162, coater 166 or painter 170, respectively, for improved the finish quality of the envelope's surface.

Step 423 checks whether the just-dispensed wind is the last wind, and if so, the printing process ends; otherwise, the process loops back to step 405, for dispensing, positioning and joining another wind to the envelope.

It will be noted that in the case of printer 102 employing the enhanced printhead 140M of FIG. 1B, some of the steps recited above as sub steps of preprint step 409, are moved to become sub steps of print step 415 according to the respective units moved from preprint unit 120 of printing module 110 to printhead 140M of printing module 110M.

### Multiple Printing Modules and Multiple Material Stores

When two or more printing modules operate simultaneously (see FIG. 2E), the steps of FIG. 16A are performed separately by each module, and are synchronized and coordinated by controller 184 for printing multiple winds in the course of a single revolution of turntable 188 (see also FIG. 7).

When two or more material stores 112 are used within a single printing module 110, the process described above may be modified as follows: (a) step 409E uses merger 136 for merging several source fibers into one build fiber (see FIGS. 8-9); (b) the material stores 112 may slightly differ in the rate of supplying source fiber for merging in step 409E, in order to produce controlled horizontal curvature of the build fiber toward printing by printhead 140; and (c) step 409D may use heater 132 to differently heat source fibers provided by different material stores, in order to produce controlled horizontal curvature of the build fiber toward printing by printhead 140.

### Operation of the Printing Module

FIG. 16B zooms-in into a printing snapshot that demonstrates the process of operating a single printing module 110 (FIG. 1A) for incrementally adding a wind of fiber to a partial envelope during printing.

It will be noted that the printing process of the present disclosure is mostly continuous: fiber is continuously positioned, dispensed and joined, and accordingly the operating units that form part of printer 102 operate mostly continuously during printing. However, for clarity and definitiveness, the process of FIG. 16B is described below as a set of discrete steps that pertain to a fiber segment, and then the set of steps is repeated for another fiber segment. Thus, in the present context, the term “fiber segment” means an arbitrarily-short section of fiber, that can be effectively dispended and joined to a previous, already-printed wind of the envelope.

It will be also noted that the printing process of the present disclosure does not involve melting of the fiber supplied from the material store. This makes the printing process much faster than comparable three-dimensional printing methods, and also allows preparing the fiber toward printing by preprinting actions performed by preprint unit 120 of printhead 140 (FIG. 1A) or by preprint modules of printhead 140M (FIG. 1B) for on-the-fly improvement of the quality and/or appearance of the finished envelope.

In step 425, printing module 110 of FIG. 1A, or printing module 110M of FIG. 1B, receives from controller 184 an instruction to append a fiber segment to the partial envelope that has been built so far, so that the added segment is properly positioned according to the desired shape of the envelope defined by three-dimensional model 196, and possibly also shaped and painted according to the desired appearance of the envelope surface. In step 427 a corresponding fiber segment is received from material store 112 by printhead 140, or, if separate preprinting is involved, by preprint unit 120. If preprinting is involved, then in optional step 429, the fiber segment is prepared toward printing by the preprinting components of either preprint unit 120 (FIG. 1A) or printhead 140M (FIG. 1B), for example by shaping, painting and/or heating. In step 435 the fiber segment is positioned by positioner 180 (e.g. by cooperation of robotic arm 146 and turntable 188) next to a previous fiber wind according to the instruction received from controller 184 which is devised to position the segment so that it adds to the desired envelope shape defined by three-dimensional model 196. In step 437, dispenser 142 (FIG. 1A) or dispenser 142B (FIG. 1B) dispenses the fiber segment next to the previous fiber wind that the point where the printhead 140/140M is positioned by positioner 180, and in step 439, joiner 144/144M joins the just-dispensed fiber segment to a corresponding segment of the previous fiber wind, for example by gluing, soldering or welding. Another loop of steps 425-439 immediately follows for continuous addition of segments, until a wind is completed in a layer-by-layer printing mode (and then the printhead's cutter may operate as needed—not shown in FIG. 16B), or until part of or the entire printing job is completed, so that the process of steps 425-439 needs to be interrupted or is concluded.

### Simultaneous Operation of Multiple Printing Modules

FIG. 16C zooms-in into a printing snapshot that demonstrates the process of operating multiple printing modules—three in the present example—as schematically illustrated in FIGS. 2E and 7, for simultaneously adding multiple winds to the built envelope in the course of a single revolution of the turntable. The process of FIG. 16C is an extension of the process of FIG. 16B for the case of multiple printing modules, thus most of the teachings of FIG. 16B may be applicable also for the process of FIG. 16C.

In step 441, a partial envelope, that has been build so far, is rotated by the turntable, in a printer that has three printing modules. In step 443A, the first printing module appends a segment of build fiber to the fiber wind that has just been added by the third printing module, as depicted in FIG. 16B and demonstrated by FIG. 7. In step 443B, the second printing module appends a segment of build fiber to the fiber wind that has just been added by the first printing module, and in step 443C, the third printing module appends a segment of build fiber to the fiber wind that has just been added by the second printing module. The process is repeated until a full revolution of the turntable is completed, thereby adding three winds to the built envelope during a single revolution of the turntable. In case of layer-by-layer printing, cutters included in the respective printheads may operate as needed (not shown in FIG. 16C).

### Multi-Session Printing

For some applications, it may be advantageous to print an envelope over an existing envelope or object, that has been previously produced by the methods of the present disclosure or by any other method. As an example, in a first session, the methods described in the present disclosure use wax fiber for producing a wax pattern; in a second session, the methods of the present disclosure are used to build a clay envelope around the wax pattern; and then, in a third session, the methods or the present disclosure are used to wrap the clay envelope with a metallic layer to strengthen the clay envelope. Each session may deploy fibers of different dimensions, profiles, properties and quality.

### Printing of Molds

The methods and systems of the present disclosure for printing envelopes, may be used for printing molds. In some cases, the printed molds will be removed after the casting sufficiently hardens, while in some other cases the mold will not interfere with the intended use of the casting, such as when building a supportive concrete column, and can remain attached to the finished casting.

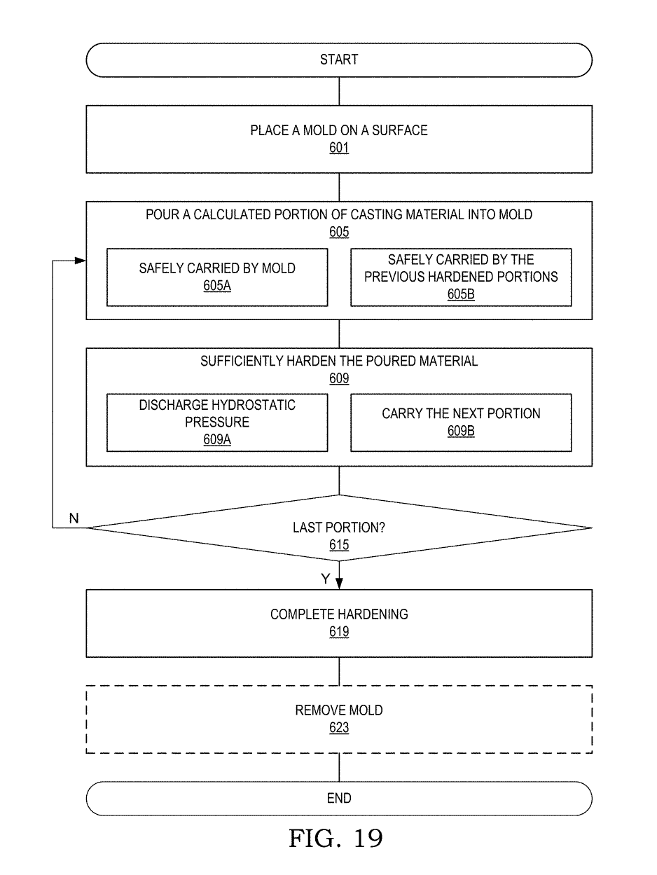

FIGS. 17A-17C are simplified illustrations demonstrating the concept of casting a shaped structure, for example, made of concrete. FIG. 17A shows a vertical cross section of a mold 454, which is an envelope built according to the teachings of the present disclosure. The fiber selected in the present example is a reinforced square fiber 230, that includes a reinforcer 230R, such as a metal wire (FIG. 3A), for better mechanical properties. Mold 454 is placed during the casting process on surface 450, such as a floor. FIG. 17B shows a cross section of mold 454, filled with a casting material, such as concrete. FIG. 17C shows the final hardened casting, after mold 454 has been removed, by mechanical, chemical and/or thermal means, except for some mold residue 454R that remain hidden below the finished casting.

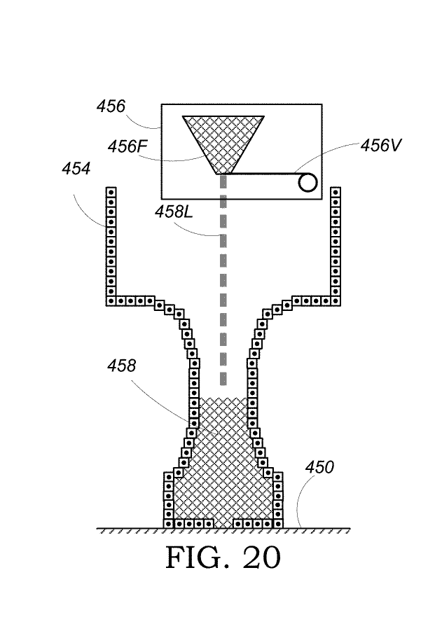

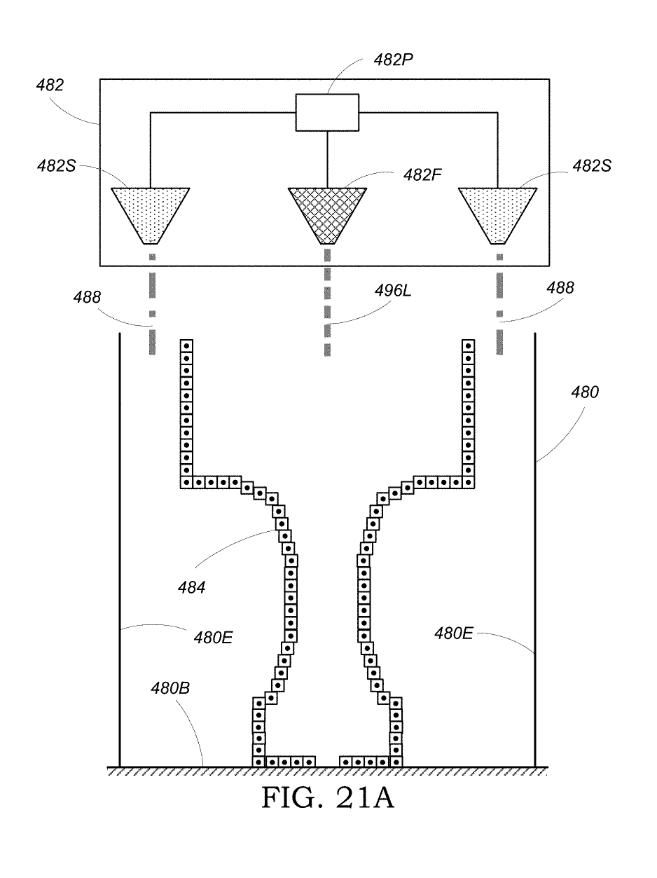

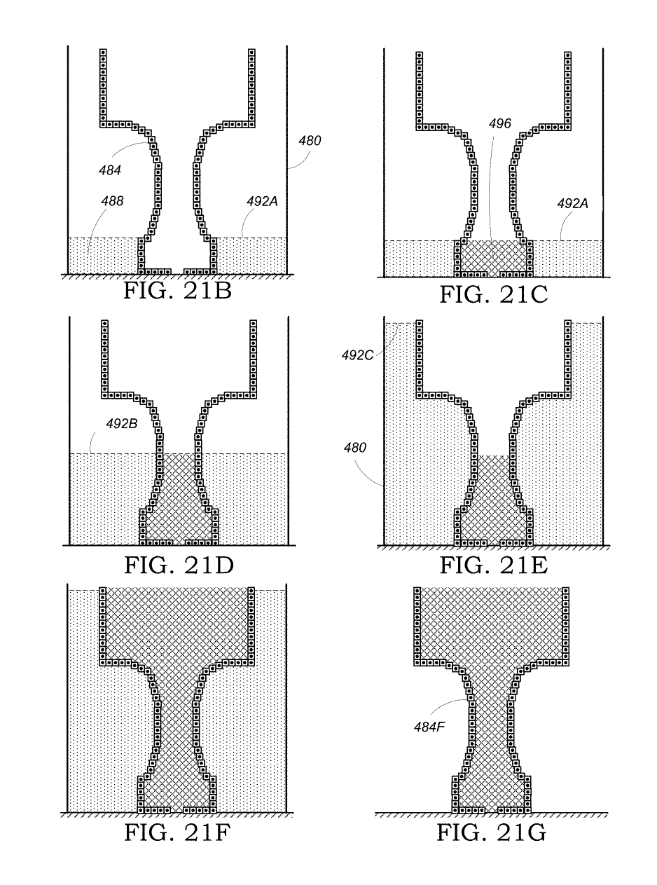

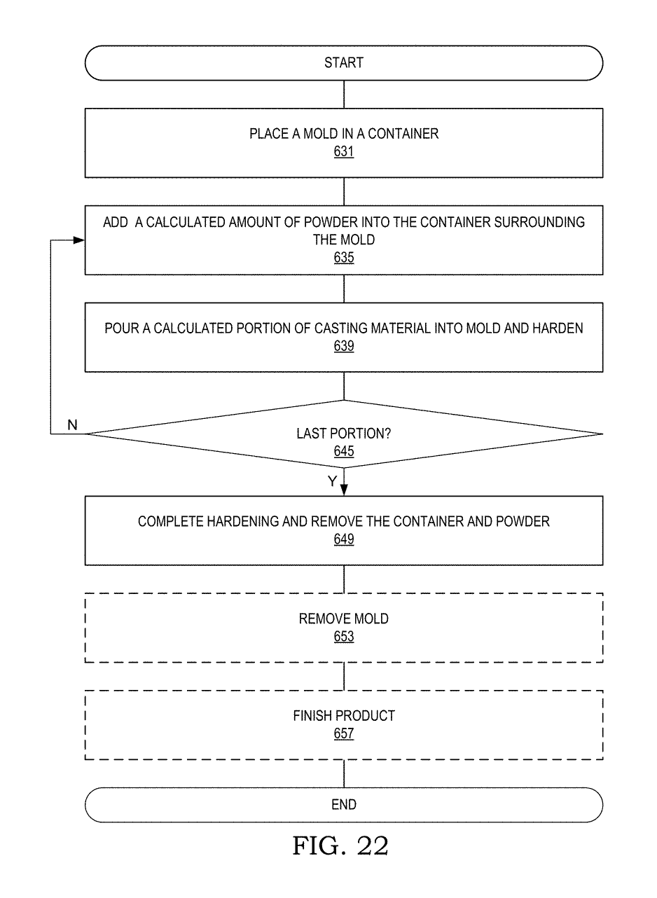

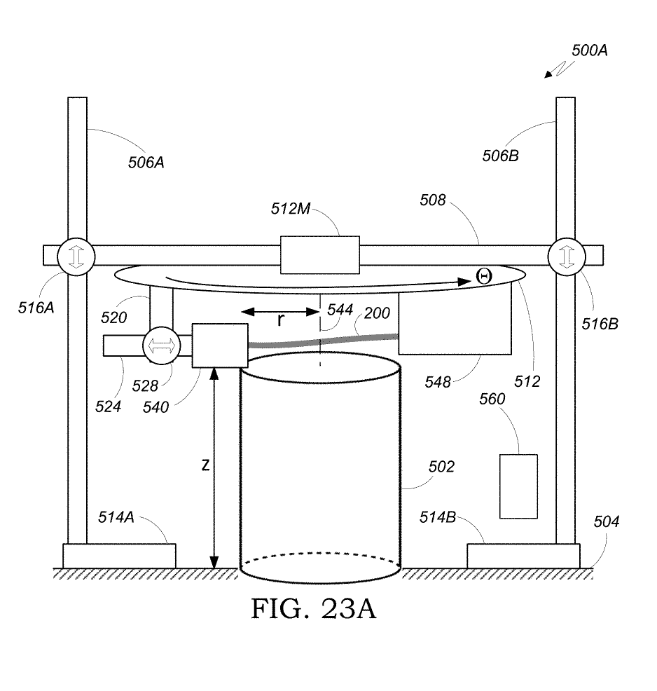

Casting is typically made by pouring the casting material, in liquid form, into the mold. It will be appreciated that, throughout the pouring process, the mold and the poured material must be properly supported, to counterweight both the weight of the poured material as well as the hydrostatic pressure developed when the poured material is still in its liquid form. FIGS. 18A-18D and FIG. 19 describe a multi-step pouring process; FIG. 20 describes a slow-pouring process; FIGS. 21A-21G and FIG. 22 describe a casting process dynamically supported by dispensing a powder, such as sand, around the mold. All those processes are devised to enable practical application of larger, thin-walled molds constructed by the printing methods of the present disclosure.

### Portion-by-Portion Pouring

The portion-by-portion pouring process described below, comes to pour a portion of casting material in liquid form, such as concrete, that can be safely supported by the mold and previous hardened portions, and then wait until the current poured material portion sufficiently hardens, to allow the next portion to be poured and adequately supported.

FIG. 18A depicts mold 454 of FIG. 17, placed on surface 450 and filled with first casting material portion 458A, in liquid form, up to first level 462A. The casting material, such as concrete, is controllably added as liquid casting material 458L by pouring device 452. Pouring device 452 includes pouring device funnel 452F whose valve (not shown) is controlled by pouring device processor 452P, for pouring controlled amounts of liquid casting material 458L. Pouring device processor 452P is aware of the detailed structure of mold 454, for example by receiving the print plan 198 (FIG. 1A) that was used to print the mold 454. Pouring device processor 452P is also aware of permitted lateral and vertical loads on each wind of mold 454, derived from calculations as well as general empirical data pertaining to the characteristics of the wind material and joining method. Thus, first level 462A is calculated by pouring device processor 452P to balance between two conflicting goals: higher speed of building, against maintaining permissible load on each wind, including a safety factor. The height of first level 462A is calculated by pouring device processor 452P to ensure that mold 454 can safely carry the poured load. As qualitatively demonstrated by the shape of the lower part of mold 454 of FIG. 18A, the dominant factor that initially needs to be overcome by the mechanical qualities of mold 454, is lateral forces developed by the hydrostatic pressure in casting material portion 458A in its liquid form. While such hydrostatic pressure reaches it maximum at the lowest wind 454A, higher winds may represent more critical points, if their joining method and angle is weaker than that of lowest wind 454A. Taking the characteristics of all winds of mold 454 into account, and including a safety factor, pouring device processor 452P calculates accordingly the first level 462A, and hence the amount of casting material in casting material portion 458A. The casting material portion 458A is left to harden for a time that is sufficient to partly solidify the casting material to discharge the hydrostatic pressure, and then pouring device 452 can continue with pouring the next portion of casting material.

FIG. 18B illustrated pouring of the second casting material portion 458B, on top of adequately-hardened casting material portion 458A of FIG. 18A (pouring device 452 not shown). The second level 462B that determines the poured amount is selected by pouring device processor 452P so that the added material does not cause excessive hydrostatic pressure on any wind of mold 454 between first level 462A and second level 462B. Also, the horizontal part of the layer, for example at and above wind 454C, as well as its hardening time, are devised by pouring device processor 452P so that it will be readied to safely carry the load of the subsequent layer (FIG. 18C). FIG. 18C illustrated casting material portion 458C that can be carried by the weakest wind in the range between second level 462B and third level 462C, such as wind 454D, and its hardening time will enable it to carry the weight of the subsequent portion. FIG. 18D schematically illustrates adding the last casting material portion 458D, reaching fourth level 462D, which is, in the present example, the top of the built casting. The last casting material portion 458D demonstrates a relatively-large amount of material poured at once, assuming that pouring device processor 452P determines that the upper part of mold 454, above third level 462C, can withstand the hydrostatic pressures initially developed by the poured liquid material, while the previously-poured portions, 458A-458C, are sufficiently hardened to carry the weight of the casting material portion 458D.

FIG. 19 is a simplified flowchart, describing a generalized portion-by-portion building process such as the process demonstrated by FIGS. 18A-18D. In step 601 a mold is placed on an even surface that can carry the finished casting. In some cases, such as when building a concrete column, the surface may be a floor where the finished casting will stay for functional and/or decorative purpose. In step 605 a calculated portion of the casting material is poured into the mold, where the calculation involves at least three criteria: (i) pouring larger portions for higher casting speed; (ii) the first pouring criterion 605A comes to ensure that the poured portion, in its liquid form, can be safely carried by the mold winds that are in contact with the poured portion; and (iii) the second pouring criterion 605B comes to ensure that the poured portion can be safely carried by the previous, fully or partly hardened, portions of casting material. In step 609 the poured portion is left to harden, to a hardening level that complies with two criteria: (i) first hardening criterion 609A that ensures that hydrostatic pressures are sufficiently discharged, so that subsequent portions will not break the winds surrounding the current portion; and (ii) second hardening criterion 609B that ensures that the hardened portion can safely carry the next portions. Steps 605-609 are repeated, for portion-by-portion pouring, until step 615 identifies that the last portion has been completed, and then step 619 allows, as needed, extra hardening time to bring the casting to its target strength. In optional step 623 the mold is removed, for example by using mechanical, chemical and/or thermal methods, and the casting process is complete.

It will be appreciated that, depending on the poured casting material, pouring may involve planar leveling and discharge of air bubbles, performed by a wiper mechanism and a vibrator (both not shown) to level each portion after its pouring is completed.

It will also be appreciated that the hardening process in step 609 depends on the casting material. For example, with concrete, waiting for a sufficient time allows sufficient setting of the originally-liquid mixture; in other examples, such as when pouring a melted metal, natural or enhanced cooling provides the required hardening.

It will be further appreciated that the casting method depicted above can be applied for casting metals, provided that the mold, including its fiber material and joining method, can withstand the temperature of the liquid poured metal.

### Slow Pouring

The portion-by-portion pouring process described above with reference to FIGS. 18A-18D and 19, is aimed at rapid casting while ensuring that the combination of the mechanical properties of the mold and the mechanical properties of the hardened previously-poured portions of the casting material can safely carry the subsequent portions. This performance comes with a price of requiring a sophisticated, processor-controlled pouring device, that requires detailed knowledge of the mold structure, as well as sophisticated models of mechanical properties of the winds, that are material- and joining method-dependent, sophisticated models of the poured casting material and its hardening, and mathematical models for taking into account all of the above.

In some cases, however, casting time may be relatively unimportant, and then the sophisticated pouring device of FIG. 18 can be replace by a simple pouring device of FIG. 20, and the sophisticated portion-by-portion pouring method is then replaced by a simple slow-pouring method as follows.

FIG. 20 schematically illustrates a pouring device 456 that slowly adds liquid casting material 458L on top of the previously-poured casting material 458 within mold 454 positioned on surface 450. Depending on the poured material, pouring device 456 may include a wiper mechanism and/or a vibrator (both not shown) to level the top surface of the poured material and discharge air bubbles. Pouring device funnel 456F is devised to pour liquid casting material 458L in slow, constant rate, so that the transient hydrostatic pressures will be safely borne by the mold 454 winds, while casting material hardening will come early enough to timely discharge electrostatic pressure and carry the weight of subsequently poured material. Ballcock valve 456F represents a simple mechanism for stopping the pouring process once the casting process is completed.

The actual pouring speed by pouring device funnel 456F can be determined by empirical data, or estimated by a skilled artisan, or afford a trial-and-error experimentation under some circumstances. For example, casting hundreds of identical decorative columns in a large garden may afford some experimentation before starting mass production.

### Powder Support

In some cases, a powder, such as sand, can be controllably added around the mold, to support the casting process. The powder does not develop hydrostatic pressure, but has its own weight, that may need, in turn, to be supported by the previously poured casting material.

FIG. 21A schematically illustrates a pouring system, where mold 484 is placed within a container 480 having a container bottom 480B and container envelope 480E. The size of container 480 is devised to accommodate mold 484 while allowing space around mold 484 to dispense powder in a way that the powder is tightly pressed against the mold's envelope so as to counter forces exerted on the envelope by casting material poured into the mold. The walls of container 480 are devised to withstand lateral forces that may develop in the powder during the pouring of the casting material. Pouring device 482 includes pouring device processor 482P that controls casting pouring funnel 482F and powder pouring dispensers 482S. Other optional components, such as mechanical wiper, vibrators and other devices intended to level the poured casting material and discharge air bubbles and/or level and compress the dispensed powder, are not shown in the figure but may be included in pouring device 482 and be operated under the control of pouring device processor 482P.

FIG. 21B depicts powder 488, such as sand, added and leveled around the bottom part of mold 484 up to first level 492A. It will be noted that powder 488 is also supported by the envelope of container 480. In FIG. 21C a first portion of casting material 496 is added and leveled up to first level 492A. Outbound forces developed by hydrostatic pressure within the initially-liquid first portion of casting material 496 and applied on the bottom part of mold 484 are balanced, as needed, by counter-forces applied by first level 492A of powder and the envelope of container 480. FIG. 21D shows the end state of a process, starting at first level 492A of FIG. 21C, of simultaneously pouring casting material 496 and dispensing powder 488, while retaining substantially the same level of both. This ensures that, continuously, the weight of the powder is supported by the added casting material, while hydrostatic pressure is counter-balanced by the powder. FIG. 21E depicts filling-up container 480 with powder surrounding mold 484. FIG. 21F shows the mold completely filled-in with the casting material, and FIG. 1G shows the completely filled mold 484F after container 480 and the powder surrounding the mold have been removed. If required, the mold may be then removed from the hardened casting, and the hardened casting may then pass finishing processes to reach its intended final shape, surface quality and appearance.

FIG. 22 is a simplified flowchart describing the general process of pouring casting material and dispensing power demonstrated in FIGS. 21A-21G above. In step 631 a mold is placed on a bottom of a container. In step 635 a calculated amount of powder (such as sand) is added and tightened between the mold and the container's walls, so that it will support the next portion of poured casting material on the one hand, and will not overload the respective winds of the mold on the other hand. In step 639 a calculated portion of casting material in liquid form is poured into the mold, so that it is supported by the respective winds of the mold and the surrounding powder, and is sufficiently hardened to support the next amount of added powder. Steps 635-639 are repeated until step 645 identifies that the last portion of liquid casting material has been poured, thus completing the casting process, and in step 649 hardening is completed and the box and surrounding powder are removed, leaving the casting wrapped by the mold. In optional step 653 the mold is removed by mechanical and/or thermal methods, while optional step 657 applies finishing processes to reach the intended final shape, surface quality and appearance.

### Hanging Turntable

The implementation illustrated in FIG. 2A includes a printer 102 placed on a surface, such as a floor, where the built envelope 104 is placed on rotating turntable 188 that is also placed on the surface.

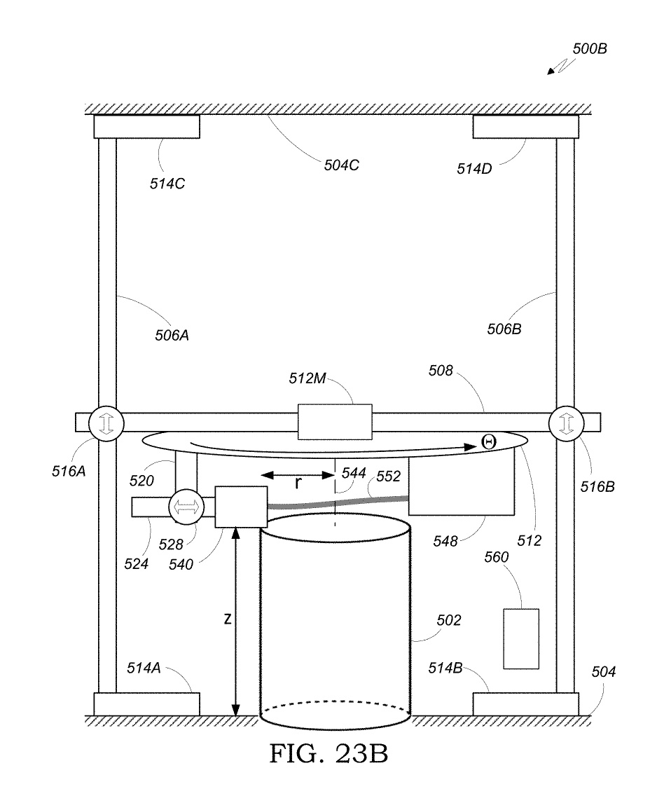

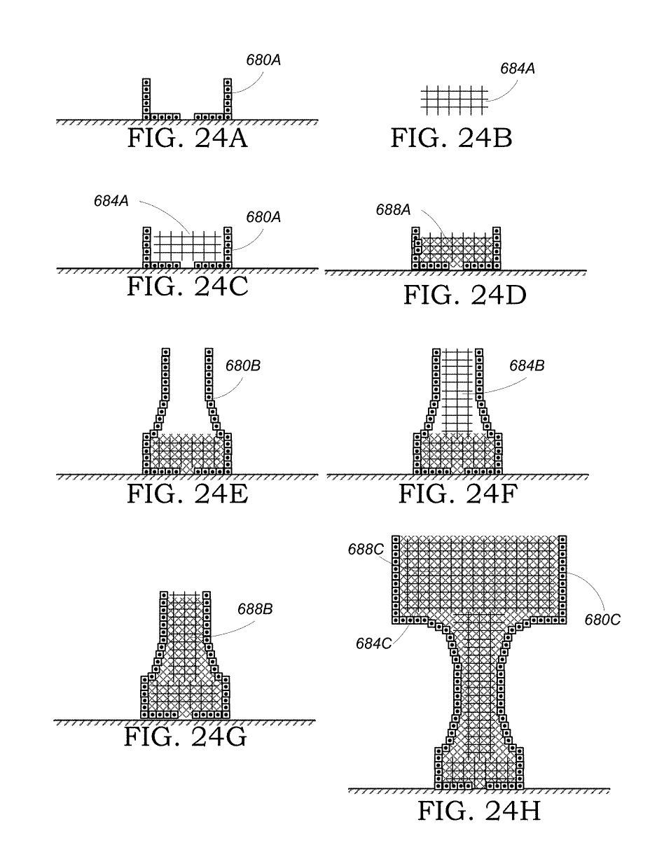

FIGS. 23A-23B depict alternative embodiments, where the built envelope is placed on a stationary surface, such as a floor, while the printing module hangs and revolves above the built envelope. Such configuration may be advantageous, for example, where a mobile printer is assembled ad-hoc to build a mold for erecting a reinforced concrete column, that will be casted concurrently with printing the mold, as will be further described with reference to FIG. 24 below.

FIG. 23A schematically illustrates a printer 500A placed on a stationary surface 504, such as a floor, for printing an envelope 502 on surface 504. Controller 560 controls the operations of all active units of printing system 500A. Base 514A and base 514B support column 506A and column 506B, respectively. Horizontal rod 508 carries turntable motor 512M that is attached to turntable 512 and rotates it around axis 544 under the control of controller 560. Turntable 512 carries material store 548 that supplies fiber 200 to printhead 540. Printhead 540 is carried by turntable 512 via rod 524 and column 520. Vertical actuator 516A and vertical actuator 516B are synchronously controlled to determine the vertical positioning of turntable 512 hence the “Z” coordinate of printhead 540, while horizontal actuator 528 is controlled by controller 560 to determine the “r” coordinate of printhead 540. The “Θ” coordinate is determined by controller 560 controlling the operation of turntable 512. Thus, by determining the (r, Θ, Z) coordinates of printhead 540, as well as the dispensing, positioning and joining operations of printhead 540, controller 560 controls the printing envelope 502. Further aspects of the printer and printing process are identical or similar to those described above with reference to printer 102 of FIG. 2A and its variety of configurations and operational modes.

FIG. 23B depicts a printer 500A that is similar to printer 500A of FIG. 23A, with the addition of further supporting column 506A and column 506B by attaching them, via ceiling anchor 514C and ceiling anchor 514D to ceiling 504C. The configuration of printer 500B offers stable printing with larger printers.

### Concurrent Mold Printing and Casting

FIGS. 24A-24H depict concurrently printing a mold and casting into the printed mold. Such a process may be used, for example, to build reinforced concrete columns, and the printers of FIGS. 23A-23B may best fit such printing tasks.

FIG. 24A shows a first mold portion 680A, which is the bottom part of a mold, printed and placed upon a surface. FIG. 24B shows a reinforcement grid, such as a steel greed for reinforcing concrete, that has been separately prepared by conventional methods. FIG. 24C shows the first grid 684A inserted into the first mold portion 680A, for example manually. FIG. 24D shows first casting material portion 688A, for example using a material such as concrete, poured into the first mold portion 680A thus filling most of the first mold portion 680A and covering most of the first grid 684A.

FIG. 24E shows a second mold portion 680B printed on top of first mold portion 680A. FIG. 24F depicts inserting a second grid 684B, sized according to the shape of second mold portion 680B, into the just-printed second mold portion 680B, while FIG. 24G depicts second casting material portion 688B poured into second mold portion 680B and covering most of second grid 684B. Finally, FIG. 24H shows the end product of printing a third mold portion 680C on top of second mold portion 680B, inserting a third grid 684C and pouring a third casting material portion 688C. Additional optional steps (not shown) may include removing the mold from the hardened casting, and finalizing the casting to improve its shape, surface quality and/or appearance.

### Printer Having No Turntable

The preferred embodiments described above included a turntable for rotating the built envelope or the printing module during positioning the printhead relatively to the envelope during printing, which offers faster printing and simpler robotic arms. It will be appreciated, however, that in some embodiments the printer may include no turntable at all, and instead employ a capable robotic arm or plotter to perform the entire positioning of printhead 140 relatively to the envelope being printed, that is then placed on a stationary base.

### Advantages

The printing methods and systems taught by the present disclosure offer at least the following advantages, in comparison to prior three-dimensional printing methods: faster printing; richer variety of materials having a wide spectrum of properties, costs and environmental friendliness; minimal amount of waste materials; and lighter builds that are easier to handle and transport. Additionally, when used for printing molds, the methods and systems taught by the present disclosure offer new possibilities for concrete casting, metal casting, as well as other casting applications.

It will be noted that while printing larger envelopes has been emphasized as the motivation for the systems and methods taught by the present disclosure, smaller envelopes can benefit from using all or part of the teachings included in the present disclosure. Also, some of the teachings of the present disclosure can be implemented in, and provide advantages to, printing methods that employ X, Y, Z plotting rather than r, Θ, Z plotting that has been described throughout the present disclosure.

While the invention has been described with respect to a limited number of embodiments, it will be appreciated by persons skilled in the art that the present invention is not limited by what has been particularly shown and described herein. Rather the scope of the present invention includes both combinations and sub-combinations of the various features described herein, as well as variations and modifications which would occur to persons skilled in the art upon reading the specification and which are not in the prior art.

What is claimed is:

1. A printer for wind-by-wind printing of three-dimensional envelopes, the printer comprising:
a controller for providing printing commands according to a three-dimensional model of a complete envelope;
a turntable for carrying and rotating a partial envelope during printing; and
at least one printing module, each printing module comprising:
at least one material store for providing at least one source fiber,
a printhead that comprises: (i) a dispenser for dispensing unmelted build fiber, and (ii) a joiner for joining the dispensed unmelted build fiber to a previous wind of the rotating partial envelope, and
a positioner controlled by the controller for positioning the printhead relatively to the previous wind of the rotating partial envelope, for said dispensing and said joining, according to the three-dimensional model of the complete envelope.

2. The printer of claim 1, wherein, for a printing module of said at least one printing module, the at least one material store consists of a single material store providing a single source fiber, and the build fiber and the single source fiber of said printing module are identical by cross section and properties.

3. The printer of claim 1, further comprising, for a printing module of said at least one printing module, a preprint unit, situated between the respective material store and printhead, for modifying the build fiber relatively to the source fiber by at least one of:
changing the source fiber's cross section,
painting the source fiber, or
heating without melting the source fiber.

4. The printer of claim 1, wherein the printhead of a printing module of said at least one printing module further comprises a heater for heating without melting the source fiber.

5. The printer of claim 1, wherein, for a printing module of said at least one printing module, the at least one material store comprises a plurality of material stores that provide a plurality of source fibers, and the printing module further comprises a merger for merging the plurality of source fibers into a single build fiber.

6. The printer of claim 5, wherein the plurality of source fibers includes at least two fibers of different properties merged by the merger.

7. The printer of claim 1, wherein said at least one printing module consists of at least two printing modules that concurrently operate for adding at least two build fiber winds to the partial envelope during a single revolution of the turntable.

8. A printer for wind-by-wind printing of three-dimensional envelopes, the printer comprising:
a controller for providing printing commands according to a three-dimensional model of a complete envelope;
a turntable for carrying and rotating a partial envelope during printing; and
at least two printing modules, each printing module comprising:
at least one material store for providing at least one source fiber,
a printhead that comprises: (i) a dispenser for dispensing unmelted build fiber, and (ii) a joiner for joining the dispensed unmelted build fiber to a previous wind of the rotating partial envelope, and
a positioner controlled by the controller for positioning the printhead relatively to the previous wind of the rotating partial envelope, for said dispensing and said joining, according to the three-dimensional model of the complete envelope;
wherein said at least two printing modules concurrently operate for adding at least two build fiber winds to the partial envelope during a single revolution of the turntable.

9. The printer of claim 8, wherein, for a printing module of said at least two printing modules, the at least one material store consists of a single material store providing a single source fiber, and the build fiber and the single source fiber of said printing module are identical by cross section and properties.

10. The printer of claim 8, further comprising, for a printing module of said at least two printing modules, a preprint unit, situated between the respective material store and printhead, for modifying the build fiber relatively to the source fiber by at least one of:
changing the source fiber's cross section,
painting the source fiber, or
heating without melting the source fiber.

11. The printer of claim 8, wherein the printhead of a printing module of said at least two printing modules further comprises a heater for heating without melting the source fiber.

12. The printer of claim 8, wherein, for a printing module of said at least two printing modules, the at least one material store comprises a plurality of material stores that provide a plurality of source fibers, and the printing module further comprises a merger for merging the plurality of source fibers into a single build fiber.

13. The printer of claim 12, wherein the plurality of source fibers includes at least two fibers of different properties merged by the merger.

14. A method of operating a printer for appending new fiber winds to previous fiber winds in the course of wind-by-wind printing of a three-dimensional envelope according to a three-dimensional model of the complete envelope, the method comprising:
rotating a partial envelope by a turntable;
positioning a printhead proximate to a previous fiber wind at a position determined according to the three-dimensional model of the complete envelope;
dispensing unmelted build fiber from the printhead;
joining the dispensed unmelted build fiber to the previous fiber wind; and
repeating said positioning, dispensing and joining steps until a new fiber wind is completed.

15. The method of claim 14, further comprising:
supplying by a material store a source fiber for being dispensed by the printhead; and
modifying the build fiber relatively to the source fiber by at least one of:
changing the source fiber's cross section,
painting the source fiber, or
heating without melting the source fiber.

16. The method of claim 14, further comprising:
supplying by a plurality of material stores a plurality of source fibers; and
subsequent to said supplying and prior to said dispensing: merging the plurality of source fibers into a single build fiber.

17. The method of claim 14, further comprising:
operating a second printhead concurrently with said printhead, for appending a second fiber wind concurrently with appending said new fiber wind.
